(19) United States
(12) Patent Application Publication
(10) Pub. No.: US 2025/0208616 A1
(43) Pub. Date: Jun. 26, 2025

(54) CONTROL DEVICE AND CONTROL SYSTEM

(71) Applicant: TOYOTA JIDOSHA KABUSHIKI KAISHA, Toyota-shi (JP)

(72) Inventor: Kento IWAHORI, Nagoya-shi (JP)

(73) Assignee: TOYOTA JIDOSHA KABUSHIKI KAISHA, Toyota-shi (JP)

(21) Appl. No.: 18/822,776

(22) Filed: Sep. 3, 2024

(30) Foreign Application Priority Data
Dec. 20, 2023 (JP) 2023-214492

(51) Int. Cl. G05D 1/221; G05D 1/244; G05D 107/70; G05D 109/10

(52) U.S. Cl. CPC G05D 1/221; G05D 1/2446; G05D 2107/70; G05D 2109/10

(57) ABSTRACT

The control device includes: an actual data acquisition unit that acquires at least one of a mark displayed on an external monitor mounted on a moving object that can be moved by remote control, acquired information that is acquired using the mark and includes identification information for identifying the moving object; a reference data acquisition unit that acquires reference data corresponding to the actual data; and a remote control unit that remotely controls the moving object, in which a process related to the movement of the moving object is different between a case where the actual data and the reference data match and a case where the actual data and the reference data do not match.

### CROSS-REFERENCE TO RELATED APPLICATION

This application claims priority to Japanese Patent Application No. 2023-214492 filed on Dec. 20, 2023, incorporated herein by reference in its entirety.

### BACKGROUND

### 1. Technical Field

The present disclosure relates to control devices and control systems.

### 2. Description of Related Art

A technique of confirming that remote control is performed on a desired vehicle has been known in the art. In this technique, a vehicle to be remotely controlled is instructed to perform a predetermined operation, and whether the instructed operation has been performed is detected using a sensor installed outside the vehicle (U.S. Pat. No. 10,532,771).

### SUMMARY

In the related art, there may be a case where a non-target vehicle that is present near a target vehicle instructed to perform a predetermined operation performs the same operation as the target vehicle for some reason. In particular, when the instructed operation is a standard operation of a vehicle such as an operation to turn on vehicle lights, the non-target vehicle may perform the same operation as the target vehicle. When the non-target vehicle performs the same operation as the target vehicle, whether the instruction was successfully sent to the target vehicle may not be able to be appropriately determined. Not only vehicles but also moving objects have the same issue.

The present disclosure can be implemented in the following aspects.
(1) A first aspect of the present disclosure provides a control device. The control device includes: an actual data acquisition unit configured to acquire actual data on either or both of a mark displayed on an external monitor mounted on a moving object that is movable by remote control and acquired information acquired using the mark, the acquired information including identification information for identifying the moving object;
a reference data acquisition unit configured to acquire reference data corresponding to the actual data; and
a remote control unit configured to remotely control the moving object and configured to perform different processes related to movement of the moving object between when the actual data and the reference data match each other and when the actual data and the reference data do not match each other. According to this aspect, the control device compares the actual data acquired using the mark with the reference data. This allows the control device to determine whether an instruction can be sent to the moving object to be controlled, without detecting whether an operation instructed to the moving object to be controlled has been performed. The control device can therefore more appropriately determine whether an instruction can be sent to the moving object to be controlled. The control device can also perform different processes related to movement of the moving object between when the actual data and the reference data match each other and when the actual data and the reference data do not match each other. That is, the control device can perform different processes related to movement of the moving object depending on the determination result as to whether an instruction can be sent to the moving object.
(2) In the above aspect, the identification information may be stored in each of a first memory of a moving object control device mounted on the moving object and a second memory of the control device.
An item of first identification information that is the identification information stored in the first memory may have been set according to a manufacturing process being performed on the moving object.
The control device may further include a process acquisition unit configured to acquire process information indicating the manufacturing process being performed on the moving object.
When the actual data acquisition unit acquires, as the actual data, the first identification information represented by the mark,
the reference data acquisition unit may acquire, as the reference data, at least information on the item according to the manufacturing process identified by the process information out of second identification information that is the identification information stored in the second memory. According to this aspect, when the first identification information represented by the mark is acquired as the actual data, the control device can acquire, as the reference data, the information on the item according to the manufacturing process identified by the process information out of the second identification information. With this configuration, the control device can acquire information on an necessary item as the reference data when comparing the actual data with the reference data.
(3-1) In the above aspect, the identification information may be stored in each of a first memory of a moving object control device mounted on the moving object and a second memory of the control device.
When the mark is generated using at least first identification information that is the identification information stored in the first memory, the first identification information represented by the mark includes unique information unique to the moving object, and the actual data acquisition unit acquires, as the actual data, the first identification information represented by the mark, the reference data acquisition unit may acquire, as the reference data, at least second identification information that is the identification information stored in the second memory, the second identification information including the unique information. According to this aspect, when the mark is generated using the first identification information and the first identification information represented by the mark includes the unique information, the control device compares the first identification information represented by the mark with the second identification information acquired as the reference data. The control device can thus determine whether an instruction can be sent to the moving object to be controlled.
(3-2) In the above aspect, the identification information may be stored in each of a first memory of a moving object control device mounted on the moving object and a second memory of the control device.
When the mark is generated using the second identification information and not using the first identification information, the second identification information represented by the mark includes the unique information, and the actual data acquisition unit acquires, as the actual data, the second identification information represented by the mark, the reference data acquisition unit may acquire, as the reference data, at least the first identification information including the unique information. According to this aspect, when the mark is generated using the second identification information and not using the first identification information, and the second identification information represented by the mark includes the unique information, the control device compares the second identification information represented by the mark with the first identification information acquired as the reference data. The control device can thus determine whether an instruction can be sent to the moving object to be controlled.
(3-3) In the above aspect, the identification information may be stored in each of a first memory of a moving object control device mounted on the moving object and a second memory of the control device.
When the mark is generated using at least the first identification information, the first identification information represented by the mark does not include the unique information and includes non-unique information other than the unique information, and the actual data acquisition unit acquires, as the actual data, the non-unique information included in the first identification information represented by the mark and the unique information acquired using access information represented by the mark, the reference data acquisition unit may acquire, as the reference data, at least the second identification information including the unique information and the non-unique information, the access information being information for accessing the first memory. According to this aspect, when the mark is generated using at least the first identification information, and the first identification information represented by the mark does not include the unique information and includes the non-unique information, the control device compares the non-unique information included in the first identification information represented by the mark with the non-unique information acquired as the reference data. The control device also compares the unique information acquired using the access information represented by the mark with the unique information acquired as the reference data. The control device can thus determine whether an instruction can be sent to the moving object to be controlled.
(4) A second aspect of the present disclosure provides a control system. The control system includes: a moving object that is movable by remote control; and
a control device installed at a place different from the moving object.
The moving object includes a communication device and a moving object control device.
The communication device includes
a generation unit configured to generate a mark using at least identification information for identifying the moving object, the identification information being information acquired from either or both of the control device and the moving object control device, and
an external monitor configured to display the mark.
The control device includes
an actual data acquisition unit configured to acquire actual data on either or both of the mark displayed on the external monitor and acquired information acquired using the mark, the acquired information including the identification information,
a reference data acquisition unit configured to acquire reference data corresponding to the actual data, and
a remote control unit configured to remotely control the moving object and configured to perform different processes related to movement of the moving object between when the actual data and the reference data match each other and when the actual data and the reference data do not match each other. According to this aspect, the control system can generate the mark using the identification information acquired from either or both of the control device and the moving object control device. The control system compares the actual data acquired using the mark with the reference data. This allows the control system to determine whether an instruction can be sent to the moving object to be controlled, without detecting whether an operation instructed to the moving object to be controlled has been performed. The control system can therefore more appropriately determine whether an instruction can be sent to the moving object to be controlled. The control system can also perform different processes related to movement of the moving object between when the actual data and the reference data match each other and when the actual data and the reference data do not match each other. That is, the control system can perform different processes related to movement of the moving object depending on the determination result as to whether an instruction can be sent to the moving object.
(5) A third aspect of the present disclosure provides a control system. The control system includes: a moving object that is movable by remote control; and
a control device installed at a place different from the moving object.
The moving object includes a communication device, the communication device including an external monitor configured to display a mark acquired from the control device.
The control device includes
a memory configured to store identification information for identifying the moving object,
a generation unit configured to generate the mark using at least the identification information stored in the memory,
an actual data acquisition unit configured to acquire actual data on either or both of the mark displayed on the external monitor and acquired information acquired using the mark, the acquired information including the identification information,
a reference data acquisition unit configured to acquire reference data corresponding to the actual data, and
a remote control unit configured to remotely control the moving object and configured to perform different processes related to movement of the moving object between when the actual data and the reference data match each other and when the actual data and the reference data do not match each other. According to this aspect, the control device can generate the mark using the identification information stored in the memory. The control system compares the actual data acquired using the mark with the reference data. This allows the control system to determine whether an instruction can be sent to the moving object to be controlled, without detecting whether an operation instructed to the moving object to be controlled has been performed. The control system can therefore more appropriately determine whether an instruction can be sent to the moving object to be controlled. The control system can also perform different processes related to movement of the moving object between when the actual data and the reference data match each other and when the actual data and the reference data do not match each other. That is, the control system can perform different processes related to movement of the moving object depending on the determination result as to whether an instruction can be sent to the moving object.
The present disclosure can be implemented in various forms other than the control device and control system described above. For example, the present disclosure can be implemented in the following forms: a moving object that is controlled by the control device, a manufacturing method of at least one of the control device, the control system, and the moving object, a control method for at least one of the control device, the control system, and the moving object, a method for identifying the moving object and the communication device mounted on the moving object, a remote control method for the moving object, a computer program that implements any of the methods, and a non-transitory recording medium storing the computer program.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a configuration of a control system;

FIG. 2 is a block diagram illustrating a configuration of a control system according to the first embodiment;

FIG. 3 is a flowchart showing a processing procedure when a vehicle is driven by remote control;

FIG. 4 is a flowchart illustrating a determination method according to the first embodiment;

FIG. 5 is a block diagram illustrating a configuration of a control system according to a second embodiment;

FIG. 6 is a first flowchart illustrating a determination method according to the second embodiment;

FIG. 7 is a second flowchart illustrating a determination method according to the second embodiment;

FIG. 8 is a third flowchart illustrating a determination method according to the second embodiment;

FIG. 9 is a block diagram illustrating a configuration of a control system according to a third embodiment;

FIG. 10 is a flowchart illustrating a determination method according to the third embodiment;

FIG. 11 is a block diagram showing a configuration of a control system according to a fourth embodiment; and

FIG. 12 is a flowchart illustrating a processing procedure when the vehicle travels by autonomous control.

### DETAILED DESCRIPTION OF EMBODIMENTS

### A. First Embodiment

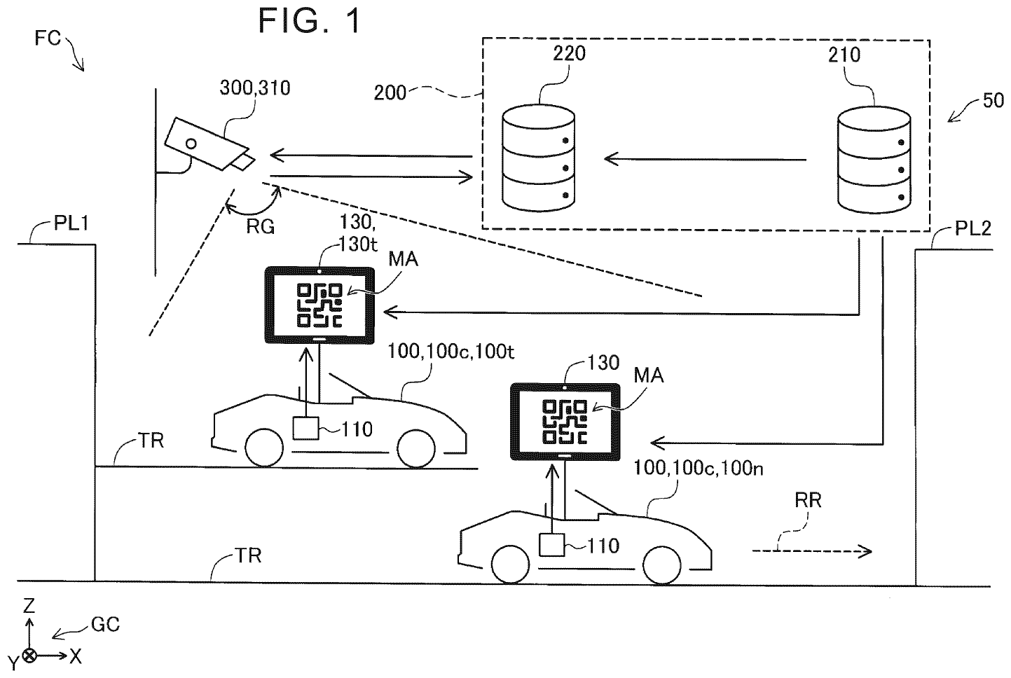

FIG. 1 is a conceptual diagram illustrating a configuration of a control system 50. The control system 50 includes one or more vehicles 100 as a moving object, a remote control device 200 as a control device, and one or more external sensors 300. The control system 50 is a system for causing the target vehicle 100t to travel without causing the non-target vehicle 100n to travel by mistake. The target vehicle 100t is the vehicle 100 to be remotely controlled. The non-target vehicle 100n is another vehicle 100 that differs from the target vehicle 100t. Hereinafter, when there is no need to distinguish the respective vehicles 100n, 100t, the vehicle is simply referred to as “vehicle 100”.

In the present disclosure, “moving object” means a movable object, and is, for example, a vehicle or an electric vertical takeoff and landing machine (a so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include battery electric vehicle (BEV: Battery Electric Vehicle), gasoline-powered vehicles, hybrid electric vehicle, and fuel cell electric vehicle. When the moving object is other than the vehicle, the expressions of “vehicle” and “car” in the present disclosure can be appropriately replaced with “moving object”, and the expression of “traveling” can be appropriately replaced with “moving”.

The vehicle 100 is configured to be able to travel by unmanned driving. The term “unmanned driving” means driving that does not depend on the traveling operation of the passenger. The traveling operation means an operation related to at least one of “running”, “turning”, and “stopping” of the vehicle 100. The unmanned driving is realized by automatic or manual remote control using a device located outside the vehicle 100 or by autonomous control of the vehicle 100. A passenger who does not perform the traveling operation may be on the vehicle 100 traveling by the unmanned driving. The passenger who does not perform the traveling operation includes, for example, a person who is simply seated on the seat of the vehicle 100 and a person who performs a work different from the traveling operation such as an assembling operation, an inspection operation, and an operation of switches while riding on the vehicle 100. Driving by the traveling operation of the occupant is sometimes referred to as “manned driving”.

Herein, “remote control” includes “full remote control” in which all of the operations of the vehicle 100 are completely determined from the outside of the vehicle 100, and “partial remote control” in which a part of the operations of the vehicle 100 is determined from the outside of the vehicle 100. Further, “autonomous control” includes “fully autonomous control” in which the vehicle 100 autonomously controls its operation without receiving any information from a device external to the vehicle 100, and “partially autonomous control” in which the vehicle 100 autonomously controls its operation using information received from a device external to the vehicle 100.

In the present embodiment, the control system 50 is used in a factory FC that manufactures the vehicles 100. The reference coordinate system of the factory FC is a global coordinate system GC, and any position in the factory FC can be represented by the coordinates of X, Y, Z in the global coordinate system GC. The factory FC includes a first location PL1 and a second location PL2. The first location PL1 and the second location PL2 are connected by a track TR on which the vehicles 100 can travel. In the factory FC, a plurality of external sensors 300 are installed along the track TR. The positions of the external sensors 300 in the factory FC are adjusted in advance. The vehicles 100 travel through the track TR from the first location PL1 to the second location PL2 by unmanned driving.

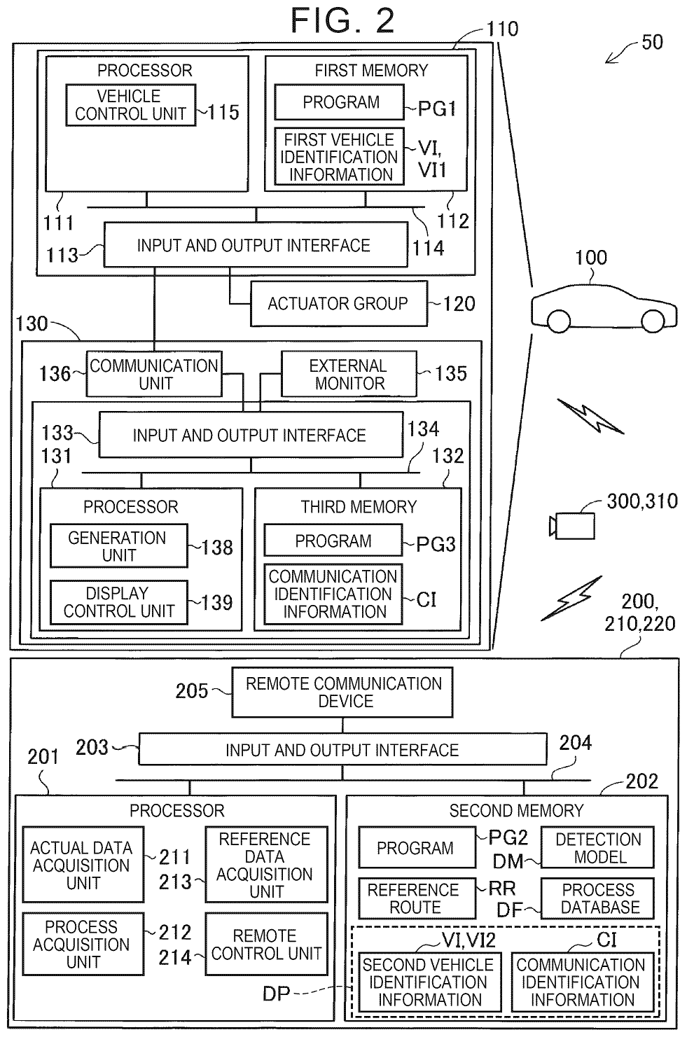

FIG. 2 is a block diagram illustrating a configuration of the control system 50 according to the first embodiment. The vehicle 100 includes a vehicle control device 110 for controlling each unit of the vehicle 100, an actuator group 120 including one or more actuators driven under the control of the vehicle control device 110, and a vehicle communication device 130 for wirelessly communicating with an external device such as the remote control device 200. The actuator group 120 includes an actuator of a driving device for accelerating the vehicle 100, an actuator of a steering device for changing a traveling direction of the vehicle 100, and an actuator of a braking device for decelerating the vehicle 100.

The vehicle control device 110 includes a computer including a processor 111, a first memory 112, an input/output interface 113, and an internal bus 114. The processor 111, the first memory 112, and the input/output interface 113 are bidirectionally communicably connected to each other via an internal bus 114. An actuator group 120 and a vehicle communication device 130 are connected to the input/output interface 113. The processor 111 executes the program PG1 stored in the first memory 112 to realize various functions including the functions of the vehicle control unit 115.

The vehicle control unit 115 controls the actuator group 120 to cause the vehicle 100 to travel. The vehicle control unit 115 can cause the vehicle 100 to travel by controlling the actuator group 120 using the travel control signal received from the remote control device 200. The travel control signal is a control signal for causing the vehicle 100 to travel. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100.

In the present embodiment, vehicle identification information VI of predetermined items is written in the first memories 112 in the respective manufacturing processes. Thus, the first memories 112 store vehicle identification information VI of predetermined items in accordance with the manufacturing process. In other words, the items of the vehicle identification information VI stored in the first memories 112 are set according to the manufacturing process. The vehicle identification information VI is information for identifying a plurality of vehicles 100. The vehicle-identification information VI is at least one of unique information and non-unique information, and includes information of one or more items. The unique information is information unique to each vehicle 100 that can uniquely identify the vehicle 100. The unique information is, for example, a vehicle identification number allocated to each vehicle 100 so as not to overlap among the plurality of vehicles 100. The vehicle-identification number is, for example, a VIN number. The non-unique information is information related to the vehicle 100 other than the unique information. The non-unique information is, for example, product number information related to a product number of hardware and software mounted on the vehicle 100. The non-unique information may be specification information about the specifications of the vehicle 100, or may be destination information about a destination indicating a region and a country where the vehicle 100 is shipped. In addition, the non-unique information may be an in-factory identification number allocated to each vehicle 100 to identify a plurality of vehicles 100 in one factory FC. The vehicle identification information VI may include, for example, time-series data indicating a transition of a state quantity indicating a state of the mounting device mounted on the vehicle 100. The vehicle identification information VI may include, for example, time-series data indicating a change in the charge rate of the main battery that supplies electric power to the traveling motor. Further, the vehicle identification information VI may include numerical information calculated by executing an arithmetic process using a predetermined function in numerical information representing a vehicle identification number, product number information, specification information, destination information, an in-plant identification number, and the like. Hereinafter, the vehicle identification information VI stored in the first memories 112 is also referred to as “first vehicle identification information VI1”.

The vehicle communication device 130 includes a processor 131, a third memory 132, an input/output interface 133, an internal bus 134, and an external monitor 135. The processor 131, the third memory 132, the input/output interface 133, and the external monitor 135 are bi-directionally communicably connected via an internal bus 134. A communication unit 136 for communicating with various devices outside the vehicle communication device 130 is connected to the input/output interface 133. The communication unit 136 can communicate with the remote control device 200 and the external sensor 300 by wireless communication, and can communicate with the vehicle control device 110 by wired communication or wireless communication. The external monitor 135 is, for example, a liquid crystal display. The external monitor 135 is disposed at a position visible from the outside of the vehicle 100. The processor 131 executes the program PG3 stored in the third memory 132 to realize various functions including the functions of the generation unit 138 and the display control unit 139.

The generation unit 138 generates mark MA. In the present embodiment, the generation unit 138 acquires the first vehicle identification information VI1 including the unique information from the vehicle control device 110. Then, the generation unit 138 generates, as the mark MA, a QR code (registered trademark, hereinafter abbreviated) representing the acquired first vehicle identification information VI1 and its own communication identification information CI. The communication identification information CI is information for identifying the plurality of vehicle communication devices 130. The communication identification information CI includes, for example, access information and a terminal-specific ID. The access information is information indicating an access destination for accessing the vehicle communication device 130. The access-information includes, for example, a IP address and a port-number of the vehicle communication device 130. The terminal-specific ID is an identifier allocated to the respective vehicle communication devices 130 so as not to overlap among the plurality of vehicle communication devices 130. The terminal-specific ID is, for example, MAC address of the vehicle communication device 130.

Note that, in the present embodiment, the mark MA is a code representing various types of information, and may be, for example, a one-dimensional code such as a bar code, a stacked two-dimensional code, or a matrix two-dimensional code other than a QR code. In other embodiments, the mark MA may be a character string representing various kinds of information such as a vehicle identification information VI, or may be a character, a figure, a symbol, a three-dimensional shape, a color, or a combination thereof, depending on various kinds of information such as a vehicle identification information VI.

The display control unit 139 causes the external monitor 135 to display the mark MA generated by the generation unit 138. At this time, the display control unit 139 may cause the external monitor 135 to display the mark MA according to a predetermined display pattern. For example, the display control unit 139 may cause the external monitor 135 to display the same mark MA in a different display pattern between the host vehicle 100 and the other vehicle 100.

The external sensor 300 is a sensor located outside the vehicle 100. The external sensor 300 in the present embodiment is a sensor that captures the vehicle 100 from the outside of the vehicle 100. The external sensor 300 includes a communication device (not shown) and can communicate with other devices such as the remote control device 200 by wired communication or wireless communication.

Specifically, the external sensor 300 is constituted by a camera. The camera as the external sensor 300 captures an image of the vehicle 100 and outputs a captured image as a detection result. Hereinafter, a camera as the external sensor 300 is also referred to as an “external camera 310”.

As shown in FIG. 1, the remote control device 200 is installed at a different location from the vehicle 100. The remote control device 200 realizes various functions including the function of the production instruction server 210 and the function of the self-propelled server 220. The production-instruction server 210 sends, to the self-propelled server 220, a travel instruction for causing the target vehicle 100t to travel by remote control. The self-propelled server 220 causes the target vehicle 100t to travel when a travel instruction for causing the target vehicle 100t to travel is received from the production-instruction server 210.

Here, the remote control device 200 causes the target vehicle 100t to travel by sending an instruction to the target vehicle 100t using, for example, access information for accessing the target communication device 130t. The target communication device 130t is the vehicle communication device 130 registered in advance in the production management database DP stored in the second memory 202 as the vehicle communication device 130 scheduled to be mounted on the target vehicle 100t. However, the same IP may be assigned to a plurality of devices in the same network. When the same IP address as IP address of the vehicle communication device 130 mounted on the target vehicle 100t is also assigned to another device used in the factory FC, the following possibility may occur. In this case, there may be a possibility that the remote control device 200 sends an instruction to another device having the same IP address as IP address of the vehicle communication device 130 mounted on the target vehicle 100t. As a result, the target vehicle 100t may not be able to travel. Further, when the same IP address as IP address of the vehicle communication device 130 mounted on the target vehicle 100t is also assigned to the vehicle communication device 130 mounted on the non-target vehicle 100n, the following possibility may occur. In this case, there may be a possibility that the remote control device 200 sends an instruction to the other vehicle communication device 130 having the same IP address as IP address of the vehicle communication device 130 mounted on the target vehicle 100t, and the vehicle communication device 130 mounted on the non-target vehicle 100n. This may cause the non-target vehicle 100n to erroneously travel. In addition, when the vehicle communication device 130 is replaced due to a failure or the like, the vehicle communication device 130 scheduled to be mounted on the target vehicle 100t may be mounted on the non-target vehicle 100n after being repaired or the like. In this case, there may be a possibility that the remote control device 200 sends an instruction to the target communication device 130t mounted on the non-target vehicle 100n. This may cause the non-target vehicle 100n to erroneously travel. As described above, it is determined whether or not an instruction can be sent to the target vehicle 100t by using only the access-information. Therefore, the remote control device 200 determines whether or not an instruction can be sent to the target vehicle 100t using the mark MA. Then, when it is determined that the instruction can be sent to the target vehicle 100t, the remote control device 200 remotely controls the operation of the target vehicle 100t via the vehicle communication device 130 to cause the target vehicle 100t to travel.

As illustrated in FIG. 2, the remote control device 200 includes a computer including a processor 201, a second memory 202, an input/output interface 203, and an internal bus 204. The processor 201, the second memory 202, and the input/output interface 203 are bidirectionally communicably connected to each other via an internal bus 204. The input/output interface 203 is connected with a remote communication device 205 for communicating with various devices external to the remote control device 200. The remote communication device 205 may communicate with the vehicle 100 by wireless communication, and may communicate with each external sensor 300 by wired communication or wireless communication.

The second memory 202 stores various types of information including a production-management-database DP. The production-management database DP is a database in which the vehicle identification information VI of one or more vehicles 100 including the target vehicle 100t and the communication identification information CI of the vehicle communication device 130 scheduled to be mounted on the respective vehicles 100 are associated with each other. Hereinafter, the vehicle identification information VI stored in the second memory 202 is also referred to as “second vehicle identification information VI2”. When the respective vehicle identification information VI1, IN2 do not need to be distinguished, they are simply referred to as “vehicle identification information VI”.

The processor 201 executes the program PG2 stored in the second memory 202 to realize various functions including functions as the actual data acquisition unit 211, the process acquisition unit 212, the reference data acquisition unit 213, and the remote control unit 214.

The actual data acquisition unit 211 acquires actual data of at least one of the mark MA displayed on the external monitor 135 and the acquired information that is acquired using the mark MA and includes the vehicle-identification information VI. In the present embodiment, the actual data acquisition unit 211 acquires captured images from the external cameras 310 capable of capturing images of areas in which the target vehicle 100t is scheduled to exist. Then, the actual data acquisition unit 211 searches for the mark MA in the captured images. When a mark MA is found in a captured image, the actual data acquisition unit 211 decodes the found mark MA. As a result, the actual data acquisition unit 211 acquires, as the actual data, acquired information represented by the mark MA. The acquired information includes the first vehicle identification information VI1 including the unique information and the communication identification information CI.

Note that, as illustrated in FIG. 1, when a plurality of vehicles 100 exist in the imaging range RG of the external camera 310 and a plurality of mark MA are found in the captured image, the actual data acquisition unit 211 decrypts all the mark MA, for example. As a result, the actual data acquisition unit 211 acquires the acquired information for all the candidate vehicle 100c that may be the target vehicle 100t.

The process acquisition unit 212 illustrated in FIG. 2 acquires process data indicating a manufacturing process being performed on the target vehicle 100t. The process information is, for example, a process ID indicating a manufacturing process being performed on the target vehicle 100t. The process ID is an identifier allocated to the respective manufacturing processes so as not to overlap among the plurality of manufacturing processes. The process information is generated by, for example, detecting a plurality of feature points that can identify a plurality of manufacturing processes from captured images obtained by capturing the target vehicle 100t, and specifying a manufacturing process being performed on the target vehicle 100t. The process information may be generated by specifying a manufacturing process being performed on the target vehicle 100t using the manufacturing control information indicating the manufacturing status of the vehicles 100 in the factory FC.

The reference data acquisition unit 213 acquires reference data corresponding to the actual data. The reference data is data to be acquired in order to match the actual data and to identify the target vehicle 100t and the non-target vehicle 100n. For example, when the actual data acquisition unit 211 acquires the mark MA as the actual data, the reference data acquisition unit 213 acquires the mark MA to be acquired as the reference data. When the actual data acquisition unit 211 acquires the acquired information represented by the mark MA as the actual data, the reference data acquisition unit 213 acquires the information corresponding to the acquired information as the reference data.

In the present embodiment, the reference data acquisition unit 213 acquires, as reference data, information on items corresponding to the manufacturing process specified by the process information and the communication identification information CI of the target communication device 130t in the second vehicle identification information VI2 of the target vehicle 100t. Specifically, the reference data acquisition unit 213 acquires items corresponding to the manufacturing process identified by the process information using the process database DF stored in the second memory 202. Thus, the reference data acquisition unit 213 specifies an item corresponding to the manufacturing process specified by the process information. The process database DF is a database in which items of the first vehicle identification information VI1 are associated with each manufacturing process. The reference data acquisition unit 213 acquires the second vehicle identification information VI2 of the items corresponding to the specified manufacturing process. For example, when the manufacturing process performed on the target vehicle 100t is the first manufacturing process and the vehicle identification number and the item number information are written in the first memory 112 in the first manufacturing process, the items corresponding to the manufacturing process specified by the process information are the vehicle identification number and the item number information. In this case, when the vehicle identification number, the item number information, the specification information, the destination information, and the factory identification number are stored in the second memory 202 as the vehicle identification information VI, the reference data acquisition unit 213 acquires the vehicle identification number and the item number information without acquiring the specification information, the destination information, and the factory identification number stored in the second memory 202. In addition, the reference data acquisition unit 213 acquires the communication identification information CI associated with the unique information of the target vehicle 100t by using the production-management-database DP stored in the second memory 202.

The remote control unit 214 determines whether or not an instruction can be sent to the target vehicle 100t by collating the actual data with the reference data. When determining that an instruction can be sent to the target vehicle 100t, the remote control unit 214 sends a travel control signal to the target vehicle 100t to cause the target vehicle 100t to travel by remote control. Thus, the remote control unit 214 causes the target vehicle 100t to travel without causing the non-target vehicle 100n to travel erroneously.

The remote control unit 214 makes the process related to the traveling of the vehicle 100 different between the case where the actual data and the reference data match and the case where the actual data and the reference data do not match. The remote control unit 214 compares the actual data with the reference data. When the actual data and the reference data coincide with each other, the remote control unit 214 can send an instruction to the target vehicle 100t, and thus determines that the target vehicle 100t is allowed to travel. When it is determined that an instruction can be sent to the target vehicle 100t, the remote control unit 214 acquires a detection result by the sensor, generates a travel control signal for controlling the actuator group 120 of the target vehicle 100t using the detection result, and sends the travel control signal to the target vehicle 100t. Thus, the remote control unit 214 causes the target vehicle 100t to travel without causing the non-target vehicle 100n to travel. On the other hand, when the actual data and the reference data do not coincide with each other, the remote control unit 214 cannot send an instruction to the target vehicle 100t, and thus determines that the target vehicle 100t must not be caused to travel. When it is determined that the instruction cannot be sent to the target vehicle 100t, the remote control unit 214 ends the process without sending the travel control signal to the target vehicle 100t.

In the present embodiment, the remote control unit 214 compares the first vehicle identification information VI1 represented by the mark MA with the second vehicle identification information VI2 of the target vehicle 100t, thereby identifying the target vehicle 100t and the non-target vehicle 100n and confirming whether or not it is the target vehicle 100t. The remote control unit 214 verifies the communication identification information CI represented by the mark MA and the communication identification information CI of the target communication device 130t to confirm whether or not the target communication device 130t is mounted on the target vehicle 100t as scheduled as indicated in the production-management-database DP. When the first vehicle identification information VI1 represented by the mark MA matches the second vehicle identification information VI2 of the target vehicle 100t, and the communication identification information CI represented by the mark MA matches the communication identification information CI of the target communication device 130t, the remote control unit 214 determines as follows. In this case, the remote control unit 214 can send an instruction to the target vehicle 100t, and thus determines that the target vehicle 100t is allowed to travel. On the other hand when at least one of the following cases is applicable; a case where the first vehicle identification information VI1 represented by the mark MA does not coincide with the second vehicle identification information VI2 of the target vehicle 100t, and a case where the communication identification information CI represented by the mark MA does not coincide with the communication identification information CI of the target communication device 130t, the remote control unit 214 determines as follows. In this case, the remote control unit 214 determines that the target vehicle 100t must not be caused to travel because the instruction cannot be sent to the target vehicle 100t.

As illustrated in FIG. 1, when the actual data acquisition unit 211 acquires the vehicle identification information VI of the plurality of candidate vehicle 100c, the remote control unit 214 collates the actual data with the reference data for each candidate vehicle 100c, for example. Then, when the actual data of the candidate vehicle 100c and the reference data coincide with each other, the remote control unit 214 determines that the candidate vehicle 100c is the target vehicle 100t and the target vehicle 100t is allowed to travel. On the other hand, when the actual data of the candidate vehicle 100c and the reference data do not coincide with each other, the remote control unit 214 determines that the candidate vehicle 100c is the non-target vehicle 100n and that the target vehicle 100t should not be caused to travel.

When the actual data acquisition unit 211 acquires the mark MA as the actual data, the reference data acquisition unit 213 acquires the mark MA as the reference data corresponding to the actual data. The remote control unit 214 compares the mark MA displayed on the external monitor 135 with the mark MA acquired as the reference data. Then, when the mark MA displayed on the external monitor 135 matches the mark MA acquired as the reference data, the remote control unit 214 can send an instruction to the target vehicle 100t, and thus determines that the target vehicle 100t is allowed to travel. On the other hand, when the mark MA displayed on the external monitor 135 and the mark MA acquired as the reference data do not coincide with each other, the remote control unit 214 cannot send an instruction to the target vehicle 100t, and thus determines that the target vehicle 100t must not be driven.

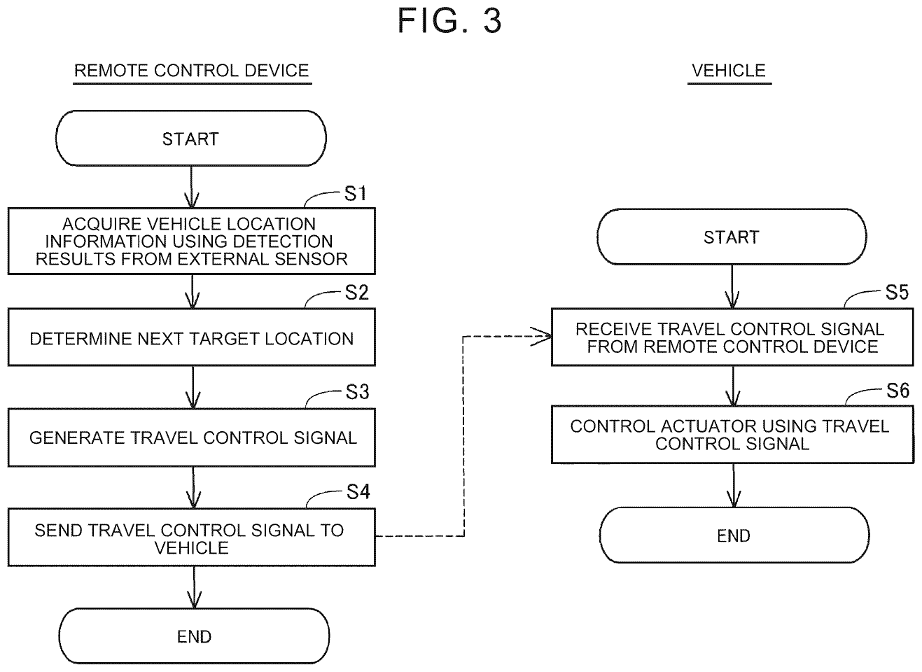

FIG. 3 is a flowchart illustrating a processing procedure of travel control when the vehicle 100 is caused to travel by remote control. In the flowchart illustrated in FIG. 3, for example, the target vehicle 100t is repeatedly performed at a predetermined cycle during a time period in which the vehicle travels by remote control.

In S1, the remote control unit 214 of the remote control device 200 acquires the vehicle position information using the detection result outputted from the external sensor 300. The vehicle position information is position information that is a basis for generating a travel control signal. In the present embodiment, the vehicle position information includes the position and orientation of the vehicle 100 in the global coordinate system GC of the factory FC. Specifically, in S1, the remote control unit 214 acquires the vehicle position data using the captured images acquired from the cameras that are the external sensors 300.

Specifically, in S1, the remote control unit 214 acquires the position of the vehicle 100 by, for example, detecting the outer shape of the vehicle 100 from the captured image, calculating the coordinate system of the captured image, that is, the coordinates of the positioning point of the vehicle 100 in the local coordinate system, and converting the calculated coordinates into the coordinates in the global coordinate system GC. The outline of the vehicle 100 included in the captured image can be detected by, for example, inputting the captured image into a detection-model DM using artificial intelligence. The detection-model DM is prepared in the control system 50 or outside the control system 50 and stored in advance in the second memory 202, for example. Examples of the detection-model DM include a learned machine learning model that is learned so as to realize one of semantic segmentation and instance segmentation. As the machine learning model, for example, a convolutional neural network (hereinafter referred to as a CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and-label due to the detection-model DM. Further, the remote control unit 214 can acquire the orientation of the vehicle 100 by estimating the orientation of the movement vector of the vehicle 100 calculated from the positional change of the feature point of the vehicle 100 between the frames of the captured image using, for example, the optical flow method.

In S2, the remote control unit 214 determines a target position to which the vehicles 100 are to be directed next. In the present embodiment, the target position is represented by the coordinates of X, Y, Z in the global coordinate system GC. The second memories 202 store in advance reference-route RR that is a route on which the vehicles 100 should travel. The route is represented by a node indicating a starting point, a node indicating a passing point, a node indicating a destination, and a link connecting the respective nodes. The remote control unit 214 uses the vehicle position information and the reference-route RR to determine a target position to which the vehicle 100 is to be directed next. The remote control unit 214 determines the target position on the reference-route RR ahead of the current position of the vehicles 100.

At S3, the remote control unit 214 generates a travel control signal for causing the vehicle 100 to travel toward the determined target position. The remote control unit 214 calculates the traveling speed of the vehicle 100 from the transition of the position of the vehicle 100, and compares the calculated traveling speed with the target speed. As a whole, the remote control unit 214 determines the acceleration so that the vehicle 100 accelerates when the traveling speed is lower than the target speed, and determines the acceleration so that the vehicle 100 decelerates when the traveling speed is higher than the target speed. Further, the remote control unit 214 determines the steering angle and the acceleration so that the vehicle 100 does not deviate from the reference-route RR when the vehicle 100 is located on the reference-route RR, and determines the steering angle and the acceleration so that the vehicle 100 returns to the reference-route RR when the vehicle 100 is not located on the reference-route RR, in other words, when the vehicle 100 deviates from the reference-route RR.

At S4, the remote control unit 214 sends the generated travel control signal to the vehicles 100. The processor 201 repeats acquisition of vehicle position information, determination of a target position, generation of a travel control signal, transmission of a travel control signal, and the like at predetermined intervals.

In S5, the vehicle control unit 115 of the vehicle control device 110 mounted on the vehicle 100 receives the travel control signal sent from the remote control device 200. In S6, the vehicle control unit 115 of the vehicle 100 controls the actuator group 120 using the received travel control signal, thereby causing the vehicle 100 to travel at the acceleration and the steering angle represented by the travel control signal. The processor 111 repeatedly receives the travel control signal and controls the actuator group 120 at a predetermined cycle. According to the control system 50 of the present embodiment, the vehicle 100 can be driven by remote control, and the vehicle 100 can be moved without using a conveyance facility such as a crane or a conveyor.

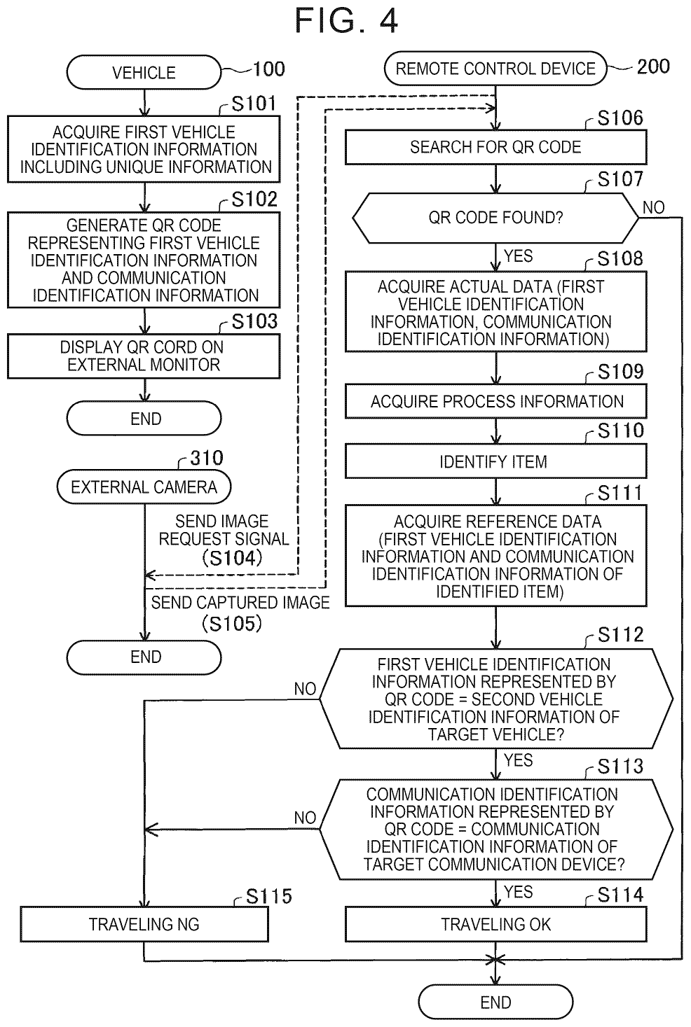

FIG. 4 is a flow chart illustrating a determination method according to the first embodiment, which determines whether an instruction can be sent to a target vehicle 100t. When the vehicle 100 is caused to travel by remote control, it is required to confirm that an instruction can be sent to the target vehicle 100t prior to starting the travel. Therefore, the process illustrated in FIG. 4 is performed, for example, prior to starting the travel of the target vehicle 100t. In this way, the target vehicle 100t can be caused to travel without causing the non-target vehicle 100n to travel erroneously. Note that the flowchart illustrated in FIG. 4 may be performed at a predetermined cycle while the target vehicle 100t is traveling. In this way, it is possible to confirm that the remote control is being performed on the target vehicle 100t at a predetermined cycle while the target vehicle 100t is traveling.

In S101, the generation unit 138 of the vehicle communication device 130 acquires the first vehicle identification information VI1 including the unique information from the vehicle control device 110. In S102, the generation unit 138 generates a QR code representing the acquired first vehicle identification information VI1 and its own communication identification information CI. In S103, the display control unit 139 causes the external monitor 135 to display a QR code representing the first vehicle identification information VI1 and the communication identification information CI. The steps from S101 to S103 are performed for each of the vehicles 100.

In S104, the actual data acquisition unit 211 of the remote control device 200 sends an image requesting signal for acquiring a captured image to the external camera 310 capable of capturing an image of an area in which the target vehicle 100t is scheduled to exist. Upon receiving the image request signal, the external camera 310 sends the captured image to the remote control device 200 in S105. In S106, the actual data acquisition unit 211 of the remote control device 200 searches for a QR code in the captured image. When a QR code is found in the captured images (S107: Yes), the actual data acquisition unit 211 decodes the found QR code according to a predetermined code standard in S108. As a result, the actual data acquisition unit 211 acquires, as the actual data, the acquired information represented by QR code. The acquired information includes the first vehicle identification information VI1 including the unique information, and the communication identification information CI. On the other hand, when QR code cannot be found in the captured image (S107: No), the control system 50 terminates this process. The case where QR code cannot be found in the captured image is, for example, a case where QR code does not exist in the captured image because the vehicles 100 do not exist in the imaging area of the external camera 310 that generated the captured image. The case where QR code cannot be found in the captured image may be a case where QR code in the captured image cannot be recognized because the image quality of the captured image is poor, or a case where QR code is not present in the captured image because QR code is not displayed on the external monitor 135.

In S109, the process acquisition unit 212 acquires process data. In S110, the reference data acquisition unit 213 uses the process-database DF to acquire items corresponding to the manufacturing process specified by the process information, thereby specifying items corresponding to the manufacturing process specified by the process information. In S111, the reference data acquisition unit 213 acquires, as reference data, information on items corresponding to the manufacturing process specified by the process information and the communication identification information CI of the target communication device 130t in the second vehicle identification information VI2 of the target vehicle 100t.

In S112, the remote control unit 214 compares the first vehicle identification information VI1 represented by QR code with the second vehicle identification information VI2 of the target vehicle 100t. In S113, the remote control unit 214 compares the communication identification information CI represented by QR code with the communication identification information CI of the target communication device 130t. The remote control unit 214 determines as shown in S114 when the first vehicle identification information VI1 represented by QR code matches the second vehicle identification information VI2 of the target vehicle 100t (S112: Yes), and when the communication identification information CI represented by QR code matches the communication identification information CI of the target communication device 130t (S113: Yes). In S114, the remote control unit 214 can send an instruction to the target vehicle 100t, and thus determines that the target vehicle 100t is allowed to travel. The remote control unit 214 determines as shown in S115 when it corresponds to at least one of a case where the first vehicle identification information VI1 represented by QR code does not match the second vehicle identification information VI2 of the target vehicle 100t (S112: No) and a case (S113: No) where the communication identification information CI represented by QR code does not match the communication identification information CI of the target communication device 130t. In S115, the remote control unit 214 determines that the target vehicle 100t must not be caused to travel because the instruction cannot be sent to the target vehicle 100t.

According to the above-described first embodiment, the remote control device 200 can acquire, as the actual data, the acquired information represented by the mark MA. The acquired information includes the first vehicle identification information VI1 including the unique information, and the communication identification information CI. The remote control device 200 can acquire the second vehicle identification information VI2 of the target vehicle 100t and the communication identification information CI of the target communication device 130t as the reference data corresponding to the actual data. The remote control device 200 can check whether or not the target vehicle 100t is the target vehicle 100t by collating the first vehicle identification information VI1 as the actual data with the second vehicle identification information VI2 as the reference data, by identifying the target vehicle 100n and the non-target vehicle. The remote control device 200 can check whether or not the target communication device 130t is mounted on the target vehicle 100t as scheduled by collating the communication identification information CI as the actual data with the communication identification information CI as the reference data. Thus, in a case where the first vehicle identification information VI1 represented by the mark MA matches the second vehicle identification information VI2 of the target vehicle 100t, and in a case where the communication identification information CI represented by the mark MA matches the communication identification information CI of the target communication device 130t, the remote control device 200 can determine that the instruction can be sent to the target vehicle 100t. When it corresponds to at least one of a case where the first vehicle identification information VI1 represented by the mark MA does not match the second vehicle identification information VI2 of the target vehicle 100t and a case where the communication identification information CI represented by the mark MA does not match the communication identification information CI of the target communication device 130t, the remote control device 200 can determine that the instruction cannot be sent to the target vehicle 100t. With such a configuration, the remote control device 200 can determine whether or not an instruction can be sent to the target vehicle 100t without detecting whether or not the operation instructed to the target vehicle 100t has been performed by the external sensor 300. In this way, since the target vehicle 100t is the vehicle 100 being manufactured, even when various devices such as lights are not mounted on the target vehicle 100t or various devices cannot be used, the remote control device 200 can determine whether or not an instruction can be sent to the target vehicle 100t. Further, in such a configuration, the remote control device 200 can determine whether or not an instruction can be sent to the target vehicle 100t by checking whether or not the target vehicle is a target vehicle 100t and whether or not the target communication device 130t is mounted as scheduled on the target vehicle 100t. With this configuration, it is possible to solve a problem that may occur when it is determined whether or not an instruction can be sent to the target vehicle 100t by using only the access-information. Therefore, the remote control device 200 can more appropriately determine whether or not an instruction can be sent to the target vehicle 100t.

Further, according to the first embodiment, the mark MA is generated using the first vehicle identification information VI1. Therefore, on the external monitor 135 of the vehicle communication device 130 mounted on the non-target vehicle 100n, the mark MA representing the first vehicle identification information VI1 of the non-target vehicle 100n is displayed. Therefore, the remote control device 200 can identify the target vehicle 100t and the non-target vehicle 100n by collating the first vehicle identification information VI1 represented by the mark MA in the captured image with the second vehicle identification information VI2 of the target vehicle 100t. Thus, the remote control device 200 can acquire the position and the direction of the target vehicle 100t by performing image analysis on the target vehicle 100t in the captured image.

Further, according to the first embodiment, the remote control device 200 searches for the mark MA in the captured image in order to acquire the actual data. At this time, if the target communication device 130t is not assigned to IP addressing that was scheduled to be assigned to the target communication device 130t and is assigned to another device other than the vehicles 100 used in the factory FC for some reason, there is no mark MA in the captured images. Therefore, when the mark MA cannot be found in the captured images, the remote control device 200 can recognize that there is a possibility that IP addressed to be assigned to the target communication device 130t is assigned to another device. When the remote control device 200 recognizes that there is a possibility that IP address that is scheduled to be assigned to the target communication device 130t is assigned to another device, it may notify the user, for example, by displaying the warning information on the external monitor 135. In this way, it is possible to notify the user that the instruction cannot be sent to the target vehicle 100t. Accordingly, it is possible to reduce a possibility that the target vehicle 100t cannot be caused to travel.

Further, according to the first embodiment, the remote control device 200 compares the communication identification information CI represented by the mark MA with the communication identification information CI of the target communication device 130t. Thus, the remote control device 200 can confirm that the target communication device 130t is mounted on the target vehicle 100t as scheduled. In this way, when the vehicle communication device 130 is replaced due to a failure or the like, the possibility that the remote control device 200 erroneously drives the non-target vehicle 100n can be reduced. In addition, when another mark MA that differs from the mark MA to be displayed on the external monitor 135 is displayed on the external monitor 135 for some reason, the remote control device 200 can reduce the possibility of erroneously driving the non-target vehicle 100n. In addition, when the medium on which the other mark MA is printed is arranged to cover the external monitor 135, the remote control device 200 can reduce the possibility of erroneously driving the non-target vehicle 100n.

Further, according to the first embodiment, the items of the first vehicle identification information VI1 are set according to the manufacturing process. The remote control device 200 can acquire process data indicating a manufacturing process being performed on the target vehicle 100t. When the first vehicle identification information VI1 is acquired as the actual data, the remote control device 200 can acquire at least the information on the items corresponding to the manufacturing process specified by the process information in the second vehicle identification information VI2 as the reference data. In this way, the remote control device 200 can acquire, as the reference data, the information of the item necessary for collating the actual data with the reference data without acquiring, as the reference data, the information of the item unnecessary for collating the actual data with the reference data.

Further, according to the above-described first embodiment, the remote control device 200 can acquire the acquired information including the first vehicle identification information VI1 including the unique information as the actual data. The remote control device 200 can acquire at least the second vehicle-identification information VI2 including the unique information as the reference data. In this way, the remote control device 200 can more accurately determine whether or not an instruction can be sent to the target vehicle 100t by using the unique information when collating the actual data with the reference data.

Further, according to the first embodiment, the vehicle communication device 130 can generate the mark MA representing the first vehicle identification information VI1 using the first vehicle identification information VI1 acquired from the vehicle control device 110. In this way, the production instruction server 210 as the remote control device 200 does not write the second vehicle identification information VI2 in the third memory 132 in advance, and the vehicle communication device 130 can generate the mark MA representing the vehicle identification information VI.

Further, according to the first embodiment, when the mark MA is generated using at least the first vehicle identification information VI1 and the first vehicle identification information VI1 includes the unique information, the remote control device 200 can be configured as follows. In this case, the remote control device 200 can determine whether or not an instruction can be sent to the target vehicle 100t without acquiring the first vehicle identification information VI1 as the reference data or collating the first vehicle identification information VI1 with the actual data.

Further, according to the first embodiment, when it is determined that the instruction can be sent to the target vehicle 100t, the remote control device 200 can cause the target vehicle 100t to travel by remote control by sending the travel control signal to the target vehicle 100t. On the other hand, when it is determined that the instruction cannot be sent to the target vehicle 100t, the remote control device 200 ends the process without sending the travel control signal to the target vehicle 100t, so that the non-target vehicle 100n can be stopped, for example, without traveling. That is, the remote control device 200 can make the process related to the traveling of the vehicle 100 different between the case where the actual data and the reference data match and the case where the actual data and the reference data do not match.

In the above-described first embodiment, when determining that the instruction can be sent to the target vehicle 100t, the remote control device 200 may send the travel control signal in which the vehicle identification information VI is associated as the supplementary information to the vehicle 100. Then, the vehicle control device 110 that has received the travel control signal may determine whether to perform the control of the actuator group 120 using the travel control signal using the supplementary information. In this case, for example, when the supplementary information and the first vehicle identification information VI1 coincide with each other, the vehicle control device 110 performs control of the actuator group 120 using the travel control signal. When the supplementary information and the first vehicle identification information VI1 do not coincide with each other, the vehicle control device 110 ends the process without executing the control of the actuator group 120 using the travel control signal. In this way, the remote control device 200 can cause the target vehicle 100t to travel without causing the non-target vehicle 100n to travel even when the same IP address is assigned to a plurality of devices in the same network. In addition, the remote control device 200 can reduce the possibility that the target vehicle 100t cannot be driven.

### B. Second Embodiment

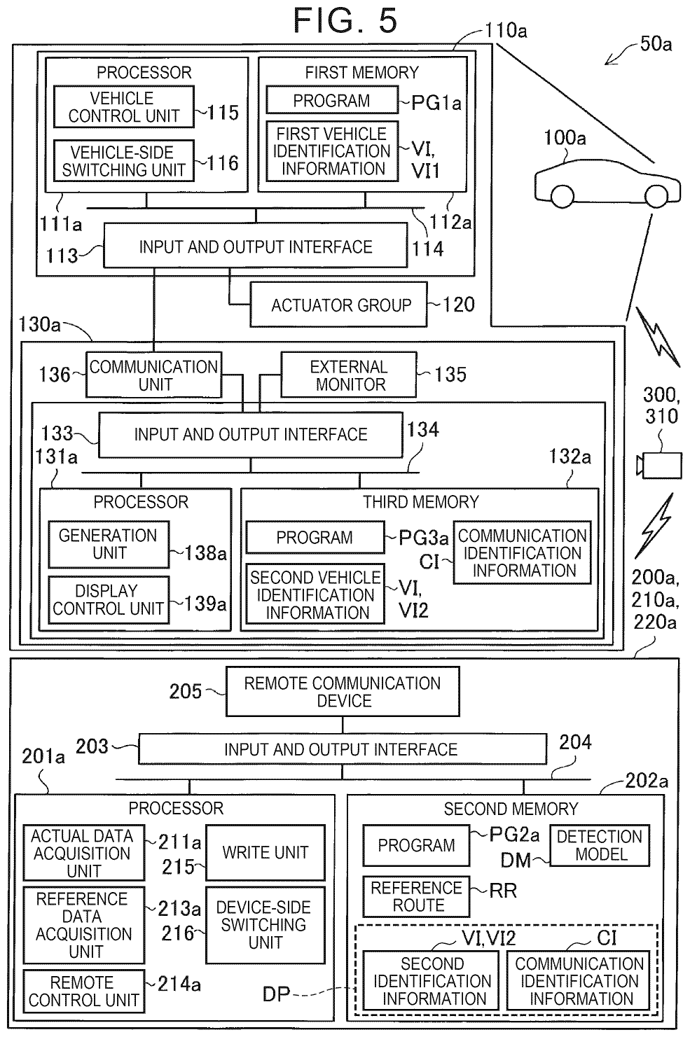

FIG. 5 is a block diagram illustrating a configuration of a control system 50a according to the second embodiment. The control system 50a includes one or more vehicle 100a, a remote control device 200a as a control device, and one or more external cameras 310. The present embodiment differs from the first embodiment in a method of generating a mark MA and a determination method of determining whether an instruction can be sent to a target vehicle 100t. Other configurations of the control system 50a are the same as those of the first embodiment unless otherwise described. The same components as those in the first embodiment are denoted by the same reference numerals, and the description thereof is omitted.

The remote control device 200a realizes various functions including a function of the production-instruction server 210a and a function of the self-propelled server 220a. The production-instruction server 210a sends a travel control signal to the target vehicle 100t as a travel instruction for causing the target vehicle 100t to travel by remote control to the self-propelled server 220. Further, the production instruction server 210a writes the second vehicle identification information VI2 of the one or more vehicle 100a including the target vehicle 100t into the third memory 132a. The self-propelled server 220a determines whether or not an instruction can be sent to the target vehicle 100t when a travel instruction for causing the target vehicle 100t to travel is received from the production-instruction server 210a. When determining that the instruction can be sent to the target vehicle 100t, the self-propelled server 220a remotely controls the operation of the target vehicle 100t via the vehicle communication device 130 to cause the target vehicle 100t to travel.

The remote control device 200a includes a computer including a processor 201a, a second memory 202a, an input/output interface 203, and an internal bus 204. The processor 201a executes the program PG2a stored in the second memory 202a to realize various functions including the functions of the writing unit 215, the device-side switching unit 216, the actual data acquisition unit 211a, the reference data acquisition unit 213a, and the remote control unit 214a.

The writing unit 215 writes the second vehicle identification information VI2 of one or more vehicle 100a including the target vehicle 100t, the second vehicle identification information VI2 including the unique information, into the third memory 132a. For example, as in the first embodiment, when the vehicle communication device 130 mounted on the target vehicle 100t is predetermined among the plurality of vehicle communication devices 130 at the time of writing the second vehicle identification information VI2 to the third memory 132a, the writing unit 215 performs the following process. In this case, the writing unit 215 writes the second vehicle identification information VI2 of the non-target vehicle 100n into the third memory 132a without writing the second vehicle identification information VI2 of the target vehicle 100t into the third memory 132a. On the other hand, when the vehicle communication device 130 mounted on the target vehicle 100t among the plurality of vehicle communication devices 130 is not determined in advance at the time of writing the second vehicle identification information VI2 to the third memory 132a, the writing unit 215 performs the following process. In this case, the writing unit 215 writes the second vehicle identification information VI2 of the plurality of vehicle 100a including the target vehicle 100t into the third memory 132a. At this time, the writing unit 215 may write the second vehicle identification information VI2 to the third memory 132a in the vehicle 100a scheduled to be produced within a time period from the time point of writing the second vehicle identification information VI2 to the third memory 132a to a predetermined time point.

When the writing unit 215 writes the second vehicle identification information VI2 of the plurality of vehicle 100a in the third memory 132a, and the mark MA does not represent the vehicle identification information VI but represents the access information, the device-side switching unit 216 performs the following process. The device-side switching unit 216 sends, to the target communication device 130t, the second vehicle identification information VI2 that is the second vehicle identification information VI2 of the target vehicle 100t and includes the unique information, using the access information represented by the mark MA as a switching instruction for switching the setting of the vehicle communication device 130a. Thus, the device-side switching unit 216 causes the vehicle communication device 130a to switch the setting of the vehicle communication device 130a by causing the vehicle communication device 130a to recognize that the vehicle is used for remote control of the target vehicle 100t.

The actual data acquisition unit 211a acquires acquired information represented by the mark MA as actual data. The actual data acquisition unit 211a may further acquire access information represented by the mark MA.

When the actual data acquisition unit 211a acquires the first vehicle identification information VI1 including the unique information, the first vehicle identification information VI1 being represented by the mark MA, and the communication identification information CI represented by the mark MA, the reference data acquisition unit 213a performs the following process. In this case, the reference data acquisition unit 213a acquires, as reference data, the second vehicle identification information VI2 that is the second vehicle identification information VI2 of the target vehicle 100t and includes the unique information, and the communication identification information CI of the target communication device 130t.

When the actual data acquisition unit 211a acquires the second vehicle identification information VI2, which is the second vehicle identification information VI2 represented by the mark MA and includes the unique information, the reference data acquisition unit 213a performs the following process. The reference data acquisition unit 213a acquires the first vehicle identification information VI1 including the unique information as reference data. At this time, the reference data acquisition unit 213a acquires the access information associated with the unique information of the target vehicle 100t using, for example, the production-management-database DP stored in the second memory 202a. Then, the reference data acquisition unit 213a acquires the first vehicle-identification information VI1 using the acquired access-information.

When the actual data acquisition unit 211 acquires the acquired information that is the first vehicle identification information VI1 represented by the mark MA and includes the first vehicle identification information VI1 including the unique information and the communication identification information CI, the remote control unit 214a performs the following process. In this case, the remote control unit 214a compares the first vehicle identification information VI1 represented by the mark MA with the second vehicle identification information VI2 of the target vehicle 100t, thereby identifying the target vehicle 100t and the non-target vehicle 100n and confirming whether or not it is the target vehicle 100t. The remote control unit 214a checks whether or not the target communication device 130t is mounted on the target vehicle 100t as scheduled by collating the communication identification information CI represented by the mark MA with the communication identification information CI of the target communication device 130t. When the first vehicle identification information VI1 represented by the mark MA matches the second vehicle identification information VI2 of the target vehicle 100t, and the communication identification information CI represented by the mark MA matches the communication identification information CI of the target communication device 130t, the remote control unit 214a determines as follows. In this case, the remote control unit 214a can send an instruction to the target vehicle 100t, and thus determines that the target vehicle 100t is allowed to travel. On the other hand, in a case where the first vehicle identification information VI1 represented by the mark MA does not match the second vehicle identification information VI2 of the target vehicle 100t, and a case where the communication identification information CI represented by the mark MA and the communication identification information CI of the target communication device 130t do not match, the remote control unit 214a determines as follows. In this case, the remote control unit 214a determines that the target vehicle 100t must not be caused to travel because the instruction cannot be sent to the target vehicle 100t.

When the actual data acquisition unit 211 acquires the second vehicle identification information VI2 that is the second vehicle identification information VI2 represented by the mark MA and includes the unique information, the remote control unit 214a performs the following process. Here, the remote control unit 214a compares the second vehicle identification information VI2 represented by the mark MA with the first vehicle identification information VI1 acquired as the reference data. Thus, the remote control unit 214a identifies the target vehicle 100t and the non-target vehicle 100n, confirms whether or not the target vehicle is a target vehicle 100t, and confirms whether or not the target communication device 130t is mounted on the target vehicle 100t as scheduled. When the second vehicle identification information VI2 represented by the mark MA and the first vehicle identification information VI1 acquired as the reference data coincide with each other, the remote control unit 214a can send an instruction to the target vehicle 100t, and thus determines that the target vehicle 100t is allowed to travel. On the other hand, when the second vehicle identification information VI2 represented by the mark MA and the first vehicle identification information VI1 acquired as the reference data do not coincide with each other, the remote control unit 214a cannot send an instruction to the target vehicle 100t, and thus determines that the target vehicle 100t must not be caused to travel.

The vehicle 100a includes a vehicle control device 110a for controlling each part of the vehicle 100a, an actuator group 120 including one or more actuators driven under the control of the vehicle control device 110a, and a vehicle communication device 130a for wirelessly communicating with an external device such as a remote control device 200a.

The vehicle-control device 110a includes a computer including a processor 111a, a first memory 112a, an input/output interface 113, and an internal bus 114. The processor 111a implements various functions including the functions of the vehicle control unit 115 and the vehicle-side switching unit 116 by executing the program PG1a stored in the first memory 112a.

When the second vehicle identification information VI2 of the plurality of vehicle 100a is written in the third memory 132a, the vehicle-side switching unit 116 acquires the first vehicle identification information VI1. When the acquired first vehicle identification information VI1 includes the unique information, the vehicle-side switching unit 116 performs the following process. In this case, the vehicle-side switching unit 116 recognizes that the vehicle is used for remote control of the host vehicle 100a among the plurality of vehicle 100a specified by the second vehicle identification information VI2 stored in the third memory 132a. Accordingly, the vehicle-side switching unit 116 switches the setting of the vehicle control device 110a. When the acquired first vehicle identification information VI1 includes the non-unique information without including the unique information, the vehicle-side switching unit 116 performs the following process. In this case, the vehicle-side switching unit 116 causes the vehicle communication device 130a to recognize the vehicle 100a specified by the unique information included in the second vehicle identification information VI2 acquired from the remote control device 200a, that is, used for remote control of the target vehicle 100t, among the plurality of vehicle 100a specified by the second vehicle identification information VI2 stored in the third memory 132a. Accordingly, the vehicle-side switching unit 116 switches the setting of the vehicle communication device 130a.

The vehicle communication device 130a includes a processor 131a, a third memory 132a, an input/output interface 133, an internal bus 134, and an external monitor 135. The processor 131a executes the program PG3a stored in the third memory 132a to realize various functions including a generation unit 138a and a function as a display control unit 139a.

The generation unit 138a generates QR code as the mark MA differently depending on whether or not the second vehicle identification information VI2 of the non-target vehicle 100n is written in the third memory 132a.

When the second vehicle identification information VI2 of the non-target vehicle 100n is not written and the second vehicle identification information VI2 of the target vehicle 100t is written in the third memory 132a, the generation unit 138a performs the following process. The generation unit 138a generates a QR code representing the second vehicle identification information VI2 by using the second vehicle identification information VI2 written in the third memory 132a by the remote control device 200a. That is, QR code is generated using the second vehicle identification information VI2 without using the first vehicle identification information VI1.

When the second vehicle identification information VI2 of the plurality of vehicle 100a is written in the third memory 132a and the setting of the vehicle communication device 130a is switched using the first vehicle identification information VI1 including the unique information, the generation unit 138a performs the following process. In this case, the generation unit 138a generates a QR code representing the first vehicle identification information VI1 including the unique information and the communication identification information CI of the vehicle communication device 130a. In other words, QR code is generated using at least the first vehicle identification information VI1.

When the second vehicle identification information VI2 of the plurality of vehicle 100a is written in the third memory 132a and the first vehicle identification information VI1 includes the non-unique information without including the unique information, the generation unit 138a performs the following process. The generation unit 138a generates a QR code representing access information for causing the vehicle communication device 130a to access. The display control unit 139a causes the external monitor 135 to display a QR code representing the access information. This enables the remote control device 200 to send the second vehicle identification information VI2 of the target vehicle 100t including the unique information to the host vehicle 100a.

When the vehicle identification information VI of the plurality of vehicle 100a is written in the third memory 132a and the setting of the vehicle communication device 130a is switched using the second vehicle identification information VI2 including the unique information, the generation unit 138a performs the following process. The generation unit 138a generates, among the second vehicle identification information VI2 of the plurality of vehicle 100a stored in the third memory 132a, a QR code representing the second vehicle identification information VI2 including the unique information corresponding to the unique information acquired from the remote control device 200a. That is, QR code is generated using the second vehicle identification information VI2 without using the first vehicle identification information VI1.

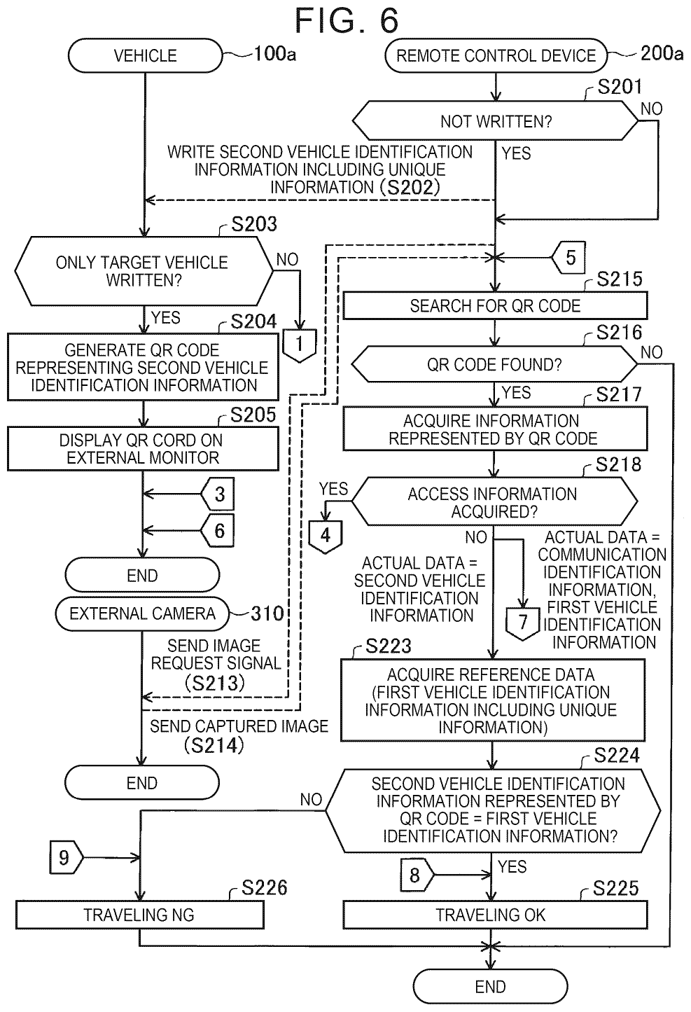

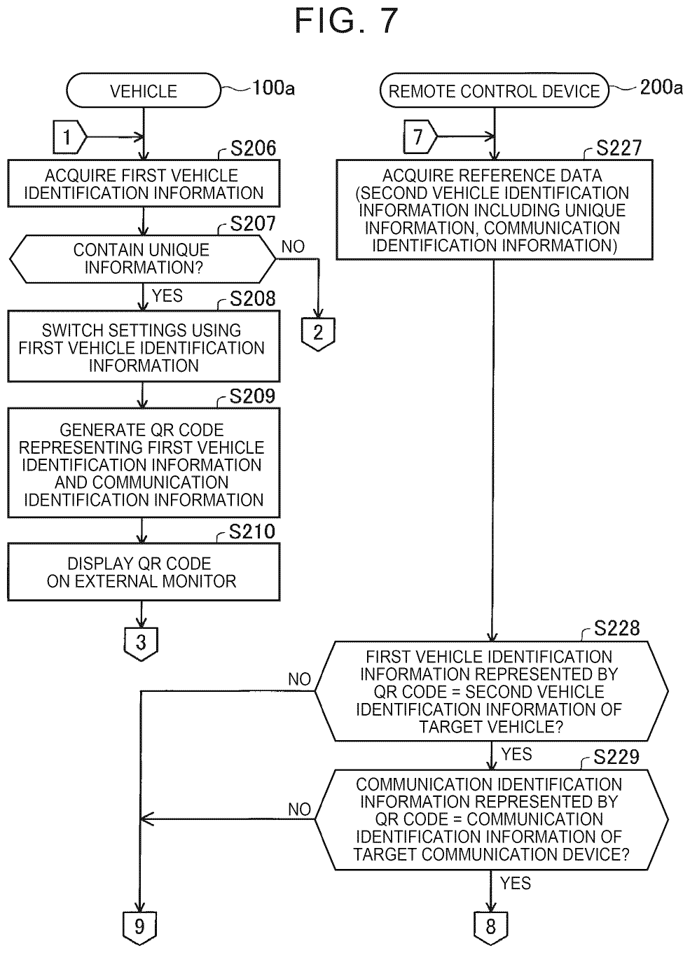

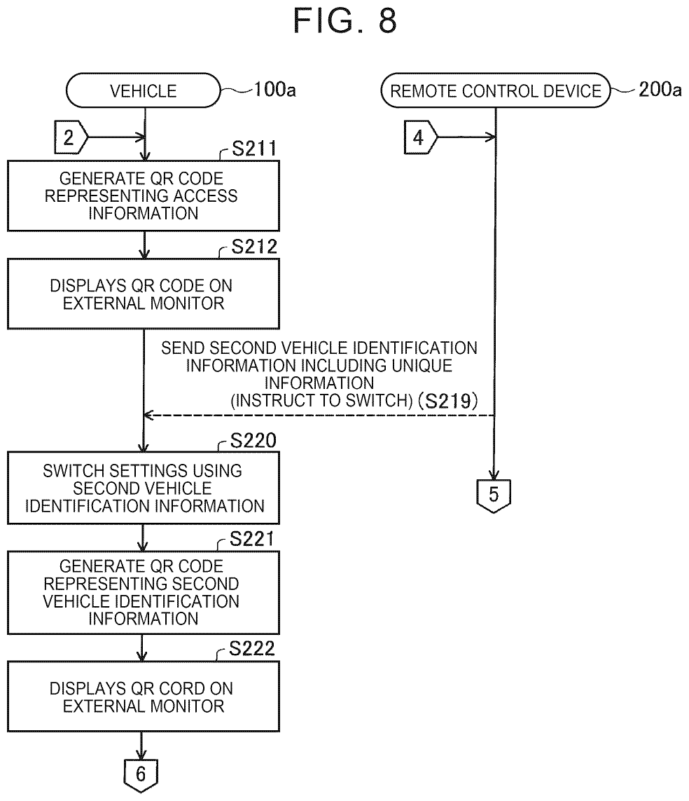

FIG. 6 is a first flowchart illustrating a determination method according to the second embodiment. FIG. 7 is a second flowchart illustrating a determination method according to the second embodiment. FIG. 8 is a third flowchart illustrating a determination method according to the second embodiment. The processes illustrated in FIGS. 6 to 8 are performed, for example, prior to starting the travel of the target vehicle 100t. Note that the processes illustrated in FIGS. 6 to 8 may be performed at a predetermined cycle while the target vehicle 100t is traveling.

As illustrated in FIG. 6, when the writing unit 215 of the remote control device 200a does not write the second vehicle identification information VI2 to the third memory 132 (S201: Yes), the writing unit 215 performs S202. In S202, the writing unit 215 writes the second vehicle identification information VI2 including the unique information, which is the second vehicle identification information VI2 of one or more vehicle 100t including the target vehicle 100a, to the third memory 132a.

When the second vehicle identification information VI2 of the target vehicle 100t is written in the third memory 132a without writing the second vehicle identification information VI2 of the non-target vehicle 100n (S203: Yes), the generation unit 138a of the vehicle communication device 130a performs S204. In S204, the generation unit 138a generates a QR code representing the second vehicle identification information VI2 using the second vehicle identification information VI2 written in the third memory 132a by the remote control device 200a. In S205, the display control unit 139a causes the external monitor 135 to display a QR code representing the second vehicle identification information VI2.

When the second vehicle identification information VI2 of the plurality of vehicle 100a is written in the third memory 132a (S203: No), the vehicle-side switching unit 116 of the vehicle control device 110a performs S206 illustrated in FIG. 7. In S206, the vehicle-side switching unit 116 acquires the first vehicle identification information VI1.

When the acquired first vehicle identification information VI1 includes the unique information (S207: Yes), the vehicle-side switching unit 116 performs S208. In S208, the vehicle-side switching unit 116 causes the vehicle communication device 130a to recognize that the vehicle is used for remote control of the host vehicle 100a among the plurality of vehicle 100a specified by the second vehicle identification information VI2 stored in the third memory 132a. Accordingly, the vehicle-side switching unit 116 switches the setting of the vehicle communication device 130a using the first vehicle identification information VI1 including the unique information. In S209, the generation unit 138a of the vehicle communication device 130a generates a QR code representing the first vehicle identification information VI1 including the unique information and the communication identification information CI. In S210, the display control unit 139a causes the external monitor 135 to display a QR code representing the first vehicle identification information VI1 including the unique information and the communication identification information CI.

When the acquired first vehicle identification information VI1 includes the non-unique information without including the unique information (S207: No), the generation unit 138a of the vehicle communication device 130a performs S211 illustrated in FIG. 8. In S211, the generation unit 138 generates a QR code representing access information for causing the vehicle communication device 130a to access. In S212, the display control unit 139a causes the external monitor 135 to display QR code representing the access information.

As illustrated in FIG. 6, in S213, the actual data acquisition unit 211a of the remote control device 200a sends an image requesting signal for acquiring a captured image to the external camera 310 capable of capturing an image of an area in which the target vehicle 100t is scheduled to exist. The external camera 310 receives the image request signal and sends the captured image to the remote control device 200a in S214. In S215, the actual data acquisition unit 211a of the remote control device 200a searches for a QR code in the captured image. When a QR code is found in a captured image (S216: Yes), S217 of the actual data acquisition unit 211a decodes the found QR code in accordance with a predetermined code standard to acquire information represented by QR code. On the other hand, when QR code cannot be found in the captured image (S216: No), the control system 50a terminates this process.

When the actual data acquisition unit 211a acquires the access information represented by QR code (S218: Yes), the device-side switching unit 216 performs S219 illustrated in FIG. 8. In S219, the device-side switching unit 216 sends, as a switching instruction, the second vehicle identification information VI2 including the unique information and the second vehicle identification information VI2 of the target vehicle 100t, to the vehicle communication device 130a by using the access information represented by QR code. The vehicle-side switching unit 116 of the vehicle communication device 130a that has received the second vehicle identification information VI2 including the unique information performs S220. In S220, the vehicle-side switching unit 116 causes the vehicle communication device 130a to recognize that the vehicle is used for remote control of the target vehicle 100t among the plurality of vehicle 100a specified by the second vehicle identification information VI2 stored in the third memory 132a. Accordingly, the vehicle-side switching unit 116 switches the setting of the vehicle communication device 130a using the second vehicle identification information VI2 including the unique information. In S221, the generation unit 138a generates, among the second vehicle identification information VI2 of the plurality of vehicle 100a stored in the third memory 132a, a QR code representing the second vehicle identification information VI2 including the unique information corresponding to the unique information acquired from the remote control device 200a. In S222, the display control unit 139a causes the external monitor 135 to display QR code representing the access information.

As illustrated in FIG. 6, when the actual data acquisition unit 211a acquires the second vehicle identification information VI2 that is the second vehicle identification information VI2 represented by QR code and includes the unique information, the reference data acquisition unit 213a performs S223. In S223, the reference data acquisition unit 213a acquires the first vehicle identification information VI1 including the unique information as the reference data by using the access information of the target communication device 130t. In S224, the remote control unit 214a compares the second vehicle identification information VI2 represented by QR code with the first vehicle identification information VI1 acquired using the access information of the target communication device 130t. When the second vehicle identification information VI2 represented by QR code matches the first vehicle identification information VI1 acquired by using the access information of the target communication device 130t (S224: Yes), the remote control unit 214a determines as shown in S225. In S225, the remote control unit 214a can send an instruction to the target vehicle 100t, and thus determines that the target vehicle 100t is allowed to travel. When the second vehicle identification information VI2 represented by QR code does not coincide with the first vehicle identification information VI1 acquired by using the access information of the target communication device 130t (S224: No), the remote control unit 214a determines as shown in S226. In S226, since the remote control unit 214a cannot send an instruction to the target vehicle 100t, it is determined that the target vehicle 100t must not be caused to travel.

When the actual data acquisition unit 211a acquires the first vehicle identification information VI1 represented by QR code, the first vehicle identification information VI1 including the unique information, and the communication identification information CI represented by QR code, the reference data acquisition unit 213a performs S227 illustrated in FIG. 7. In S227, the reference data acquisition unit 213a acquires, as reference data, the second vehicle identification information VI2 that is the second vehicle identification information VI2 of the target vehicle 100t and includes the unique information, and the communication identification information CI of the target communication device 130t. In S228, the remote control unit 214a compares the first vehicle identification information VI1 represented by QR code with the second vehicle identification information VI2 of the target vehicle 100t. In S229, the remote control unit 214a compares the communication identification information CI represented by QR code with the communication identification information CI of the target communication device 130t. When the first vehicle identification information VI1 represented by QR code matches the second vehicle identification information VI2 of the target vehicle 100t (S228: Yes), and when the communication identification information CI represented by QR code matches the communication identification information CI of the target communication device 130t (S229: Yes), the remote control unit 214a can send an instruction to the target vehicle 100t as illustrated in S225 of FIG. 6, and thus determines that the target vehicle 100t may be caused to travel. On the other hand, as shown in FIG. 7, when at least one of the first vehicle identification information VI1 represented by QR code and the second vehicle identification information VI2 of the target vehicle 100t does not coincide with each other (S228: No), and when (S229: No) the communication identification information CI represented by QR code and the communication identification information CI of the target communication device 130t do not coincide with each other, the remote control unit 214a cannot send an instruction to the target vehicle 100t as shown in S226 of FIG. 6, and thus it is determined that the target vehicle 100t should not be driven.

According to the second embodiment, the remote control device 200a can write the second vehicle-identification information VI2 including the unique information into the third memory 132a by using the access information. Accordingly, the vehicle communication device 130a can perform the following process. In this case, the vehicle communication device 130a may generate the mark MA representing the second vehicle identification information VI2 using the second vehicle identification information VI2 acquired from the remote control device 200a. In this way, it is possible to generate the mark MA representing the vehicle identification information VI without acquiring the first vehicle identification information VI1 from the vehicle control device 110a.

Further, according to the second embodiment, when the second vehicle identification information VI2 of the plurality of vehicle 100a is written in the third memory 132a and the first vehicle identification information VI1 includes the unique information, the vehicle communication device 130a can perform the following process. In this case, the vehicle communication device 130a can generate the mark MA representing the first vehicle identification information VI1 using the first vehicle identification information VI1 without using the second vehicle identification information VI2.

Further, according to the second embodiment, when the second vehicle identification information VI2 of the plurality of vehicle 100a is written in the third memory 132a and the first vehicle identification information VI1 includes the non-unique information without including the unique information, the vehicle communication device 130a can perform the following process. The vehicle communication device 130a may generate a QR code representing the access information. The vehicle communication device 130a may obtain the second vehicle identification information VI2 including the unique information from the remote control device 200a by using QR code representing the access information. Accordingly, the vehicle communication device 130a can generate the mark MA representing the second vehicle identification information VI2 by using the second vehicle identification information VI2.

Further, according to the second embodiment, when the mark MA is generated using the second vehicle identification information VI2 without using the first vehicle identification information VI1 and the second vehicle identification information VI2 represented by the mark MA includes the unique information, the remote control device 200a can perform the following process. In this case, the remote control device 200a can acquire, as the actual data, the second vehicle identification information VI2 that is the second vehicle identification information VI2 represented by the mark MA and includes the unique information. The remote control device 200a may acquire the first vehicle-identification information VI1 including the unique information as the reference data corresponding to the actual data. The remote control device 200a compares the second vehicle identification information VI2 as the actual data with the first vehicle identification information VI1 as the reference data. Thus, the remote control device 200a can determine whether or not the instruction can be sent to the target vehicle 100t when the mark MA is generated using the second vehicle identification information VI2 and not using the first vehicle identification information VI1 and the second vehicle identification information VI2 represented by the mark MA includes the unique information.

Further, according to the second embodiment, when the first vehicle identification information VI1 is used to generate the mark MA and the first vehicle identification information VI1 represented by the mark MA includes the unique information, the remote control device 200a can perform the following process. In this case, the remote control device 200a can acquire, as the actual data, the first vehicle identification information VI1 that is the first vehicle identification information VI1 represented by the mark MA and includes the unique information. The remote control device 200a may acquire the second vehicle-identification information VI2 including the unique information as the reference data corresponding to the actual data. The remote control device 200a compares the first vehicle identification information VI1 as the actual data with the second vehicle identification information VI2 as the reference data. Thus, the remote control device 200a can determine whether or not an instruction can be sent to the target vehicle 100t when the mark MA is generated using at least the first vehicle identification information VI1 and the first vehicle identification information VI1 represented by the mark MA includes the unique information.

### C. Third Embodiment

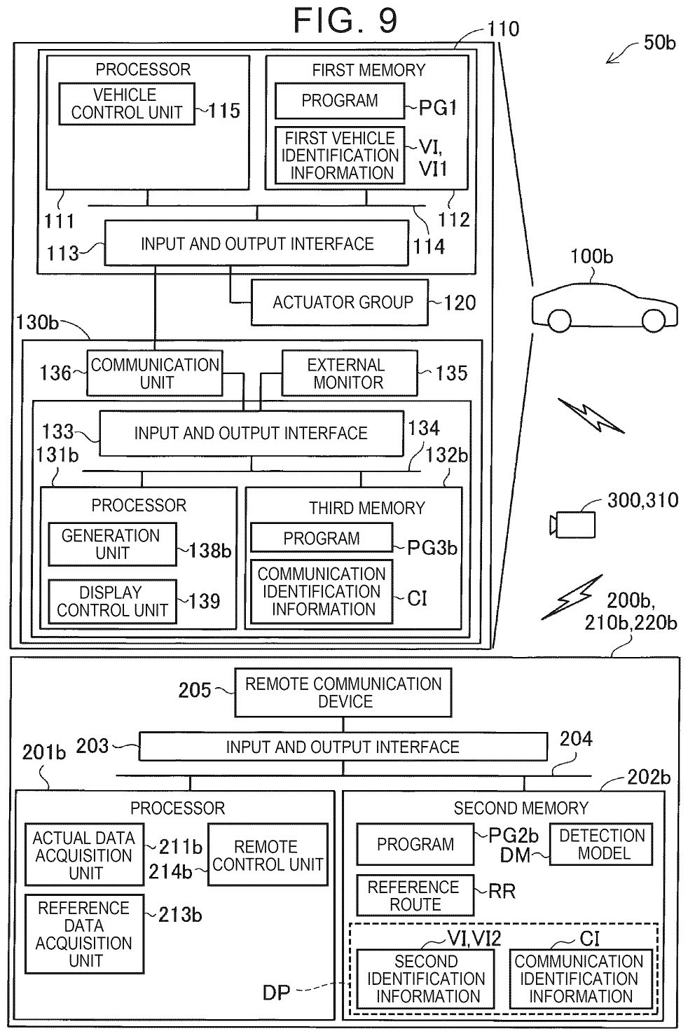

FIG. 9 is a block diagram illustrating a configuration of a control system 50b according to a third embodiment. The control system 50b includes one or more vehicle 100b, a remote control device 200b as a control device, and one or more external cameras 310. The present embodiment differs from the first embodiment in the items of the vehicle identification information VI represented by the mark MA and the determination methods for determining whether an instruction can be sent to the target vehicle 100t. Other configurations of the control system 50b are the same as those of the first embodiment unless otherwise described. The same components as those in the first embodiment are denoted by the same reference numerals, and the description thereof is omitted.

The remote control device 200b realizes various functions including a function of the production-instruction server 210b and a function of the self-propelled server 220b. The production-instruction server 210b sends, to the self-propelled server 220, a travel instruction for causing the target vehicle 100t to travel by remote control. The self-propelled server 220b causes the target vehicle 100t to travel when a travel instruction for causing the target vehicle 100t to travel is received from the production-instruction server 210.

The remote control device 200b includes a computer including a processor 201b, a second memory 202b, an input/output interface 203, and an internal bus 204. The processor 201b executes the program PG2b stored in the second memory 202b to realize various functions including the functions of the actual data acquisition unit 211b, the reference data acquisition unit 213b, and the remote control unit 214b.

When the mark MA is generated using at least the first vehicle identification information VI1 and the first vehicle identification information VI1 represented by the mark MA includes the non-unique information without including the unique information, the actual data acquisition unit 211b performs the following process. In this case, the actual data acquisition unit 211b acquires, as the actual data, the non-unique information represented by the mark MA, that is, the first vehicle-identification information VI1 represented by the mark MA. Further, the actual data acquisition unit 211b acquires the unique information stored in the first memory 112 by accessing the first memory 112 using the access information represented by the mark MA as the actual data.

When the mark MA is generated using at least the first vehicle identification information VI1 and the first vehicle identification information VI1 represented by the mark MA includes the non-unique information without including the unique information, the reference data acquisition unit 213b performs the following process. In this case, the reference data acquisition unit 213b acquires, as the reference data, the second vehicle identification information VI2 including the unique information of the target vehicle 100t and the non-unique information of the same item as the non-unique information included in the first vehicle identification information VI1 acquired as the actual data among the non-unique information of the target vehicle 100t.

When the first vehicle identification information VI1 is used at least to generate the mark MA, and the first vehicle identification information VI1 represented by the mark MA includes the non-unique information without including the unique information, the remote control unit 214b performs the following process. In this case, the remote control unit 214b collates the non-unique information represented by the mark MA with the non-unique information of the target vehicle 100t acquired as the reference data in the second vehicle identification information VI2. Further, the remote control unit 214b collates the unique information acquired by accessing the first memory 112 using the access information represented by the mark MA with the unique information of the target vehicle 100t acquired as the reference data in the second vehicle identification information VI2. The non-specific information represented by the mark MA and the non-unique information of the second vehicle identification information VI2, when the non-unique information of the target vehicle 100t acquired as the reference data coincides with each other and the unique information acquired by accessing the first memory 112 using the access information represented by the mark MA is coincident with each other, and when the unique information of the target vehicle 100t acquired as the reference data among the second vehicle identification information VI2 coincides with each other, the remote control unit 214b determines as follows. In this case, the remote control unit 214b can send an instruction to the target vehicle 100t, and thus determines that the target vehicle 100t is allowed to travel. On the other hand, when it corresponds to at least one of a case where the non-unique information represented by the mark MA does not match the non-unique information of the second vehicle identification information VI2 and the non-unique information of the target vehicle 100t obtained as the reference data, and a case where the unique information obtained by accessing the first memory 112 using the access information represented by the mark MA does not match the unique information of the target vehicle 100t obtained as the reference data in the second vehicle identification information VI2, the remote control unit 214b determines as follows. In this case, the remote control unit 214b determines that the target vehicle 100t must not be caused to travel because the instruction cannot be sent to the target vehicle 100t.

The vehicle 100b includes a vehicle control device 110 for controlling each unit of the vehicle 100b, an actuator group 120 including one or more actuators driven under the control of the vehicle control device 110, and a vehicle communication device 130b for wirelessly communicating with an external device such as a remote control device 200b.

The vehicle communication device 130b includes a processor 131b, a third memory 132b, an input/output interface 133, an internal bus 134, and an external monitor 135. The processor 131b executes the program PG3b stored in the third memory 132b to realize various functions including the generation unit 138b and the function as the display control unit 139.

The generation unit 138b acquires the first vehicle identification information VI1 including the non-unique information from the vehicle control device 110 without including the unique information. Then, the generation unit 138b generates, as the mark MA, a QR code representing the first vehicle-identification information VI1 including the non-unique information without including the unique information.

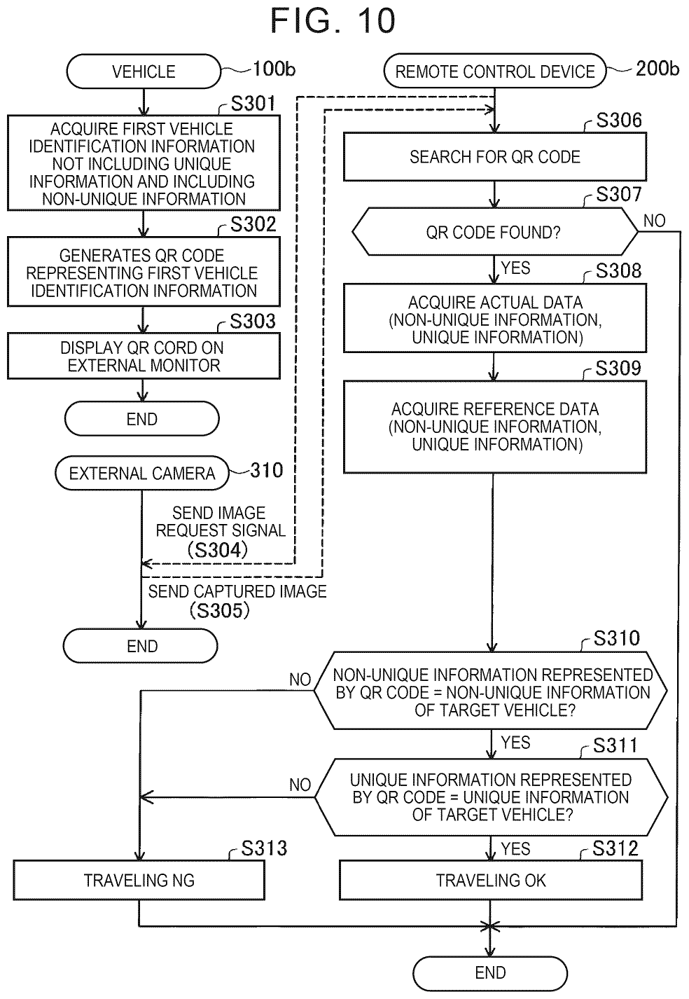

FIG. 10 is a flowchart illustrating a determination method according to the third embodiment. The process illustrated in FIG. 10 is performed, for example, prior to starting the travel of the target vehicle 100t. Note that the flowchart illustrated in FIG. 10 may be performed at a predetermined cycle while the target vehicle 100t is traveling.

In S301, the generation unit 138b of the vehicle communication device 130 acquires the first vehicle identification information VI1 including the non-unique information without including the unique information from the vehicle control device 110. In S302, the generation unit 138b generates a QR code representing the acquired first vehicle identification information VI1. In S303, the display control unit 139 causes the external monitor 135 to display a QR code representing the first vehicle identification information VI1. The steps from S301 to S303 are performed for each 100b of vehicles.

In S304, the actual data acquisition unit 211b of the remote control device 200b sends an image requesting signal for acquiring a captured image to the external camera 310 capable of capturing an image of an area where the target vehicle 100t is scheduled to exist. The external camera 310 receives the image request signal and sends the captured image to the remote control device 200b in S305. In S306, the actual data acquisition unit 211b of the remote control device 200b searches for a QR code in the captured image. When a QR code is found in a captured image (S307: Yes), the actual data acquisition unit 211b decodes the found QR code according to a standard of a predetermined code in S308. As a result, the actual data acquisition unit 211b acquires, as the actual data, the non-unique information represented by the mark MA and the unique information acquired by accessing the first memory 112 using the access information represented by the mark MA. On the other hand, when QR code cannot be found in the captured image (S307: No), the control system 50b terminates this process.

In S309, the reference data acquisition unit 213b acquires, as the reference data, the second vehicle identification information VI2 including the unique information of the target vehicle 100t and the non-unique information of the same item as the non-unique information included in the first vehicle identification information VI1 acquired as the actual data among the non-unique information of the target vehicle 100t.

In S310, the remote control unit 214b compares the non-unique information represented by the mark MA with the non-unique information of the target vehicle 100t acquired as the reference data in the second vehicle identification information VI2. In S311, the remote control unit 214b collates the unique information acquired by accessing the first memory 112 using the access information represented by the mark MA with the unique information of the target vehicle 100t acquired as the reference data in the second vehicle identification information VI2. When the non-unique information represented by the mark MA matches the non-unique information of the target vehicle 100t acquired as the reference data among the second vehicle identification information VI2 (S310: Yes), and the unique information acquired by accessing the first memory 112 using the access information represented by the mark MA matches the unique information of the target vehicle 100t acquired as the reference data among the second vehicle identification information VI2 (S311: Yes), the remote control unit 214b determines as shown in S312. In S312, the remote control unit 214b can send an instruction to the target vehicle 100t, and thus determines that the target vehicle 100t is allowed to travel. On the other hand, in a case where the non-unique information represented by the mark MA does not coincide with the non-unique information of the target vehicle 100t acquired as the reference data among the second vehicle identification information VI2 (S310: No), and in a case where the unique information acquired by accessing the first memory 112 using the access information represented by the mark MA and the unique information of the target vehicle 100t acquired as the reference data among the second vehicle identification information VI2 do not coincide with each other (S311: No), the remote control unit 214b determines as shown in S313. In S313, since the remote control unit 214b cannot send an instruction to the target vehicle 100t, it is determined that the target vehicle 100t must not be caused to travel.

According to the third embodiment, when the mark MA is generated using at least the first vehicle identification information VI1 and the first vehicle identification information VI1 represented by the mark MA includes the non-unique information without including the unique information, the remote control device 200b can perform the following process. Here, the remote control device 200a can be used as the actual data. The non-unique information represented by the mark MA can be used. Further, the remote control device 200a can acquire the unique information stored in the first memory 112 by accessing the first memory 112 using the access information represented by the mark MA as the actual data. The remote control device 200b can acquire, as the reference data corresponding to the actual data, the second vehicle identification information VI2 including the unique information of the target vehicle 100t and the non-unique information of the same items as the non-unique information included in the first vehicle identification information VI1 acquired as the actual data among the non-unique information of the target vehicle 100t. The remote control device 200b can compare the non-unique information represented by the mark MA with the non-unique information of the target vehicle 100t obtained as the reference data in the second vehicle identification information VI2. The remote control device 200b can collate the unique information acquired by accessing the first memory 112 using the access information represented by the mark MA with the unique information of the target vehicle 100t acquired as the reference data in the second vehicle identification information VI2. Thus, the remote control device 200b can determine whether or not an instruction can be sent to the target vehicle 100t when the mark MA is generated using at least the first vehicle identification information VI1 and the first vehicle identification information VI1 represented by the mark MA includes the non-unique information without including the unique information.

### D. Fourth Embodiment

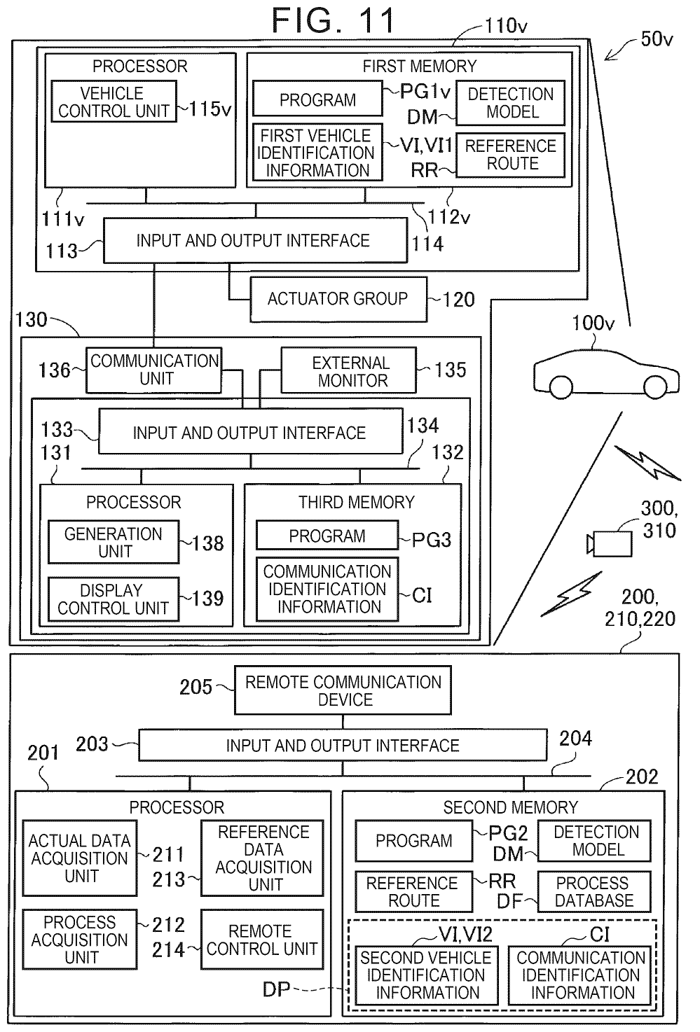

FIG. 11 is a block diagram illustrating a configuration of a control system 50v according to a fourth embodiment. The vehicle 100v according to the present embodiment can further travel by autonomous control of the vehicle 100v. Other configurations are the same as those of the first embodiment unless otherwise described.

In the present embodiment, the processor 111v of the vehicle control device 110v functions as the vehicle control unit 115v by executing the program PG1v stored in the memory 112v. The vehicle control unit 115v can cause the vehicle 100v to travel by autonomous control by acquiring an output result from the sensor, generating a travel control signal using the output result, and outputting the generated travel control signal to operate the actuator group 120. In the present embodiment, in addition to the program PG1v, the detection-model DM and the reference-path RR are stored in advance in the memory 112v.

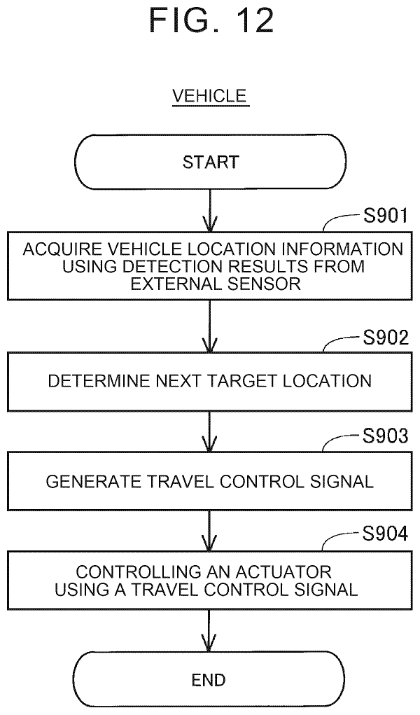

FIG. 12 is a flow chart showing a process sequence of travel control when the vehicle 100v travels by autonomous control. In the flowchart illustrated in FIG. 12, for example, 100v is repeatedly performed at a predetermined cycle during a time in which the vehicle travels by autonomous control.

In S901, the vehicle control unit 115v of the vehicle control device 110v acquires the vehicle position information using the detection result outputted from the camera as the external sensor 300. In S902, the vehicle control unit 115v determines a target position to which the vehicle 100v is to be directed next. In S903, the vehicle control unit 115v generates a travel control signal for causing the vehicle 100v to travel toward the determined target position. In S904, the vehicle control unit 115v controls the actuator group 120 by using the generated travel control signal, thereby causing the vehicle 100v to travel in accordance with the parameter represented by the travel control signal. The processor 111v repeats acquiring the vehicle position information, determining the target position, generating the travel control signal, and controlling the actuator at a predetermined cycle. According to the control system 50v of the present embodiment, the vehicle 100v can be driven by the autonomous control of the vehicle 100v without remotely controlling the vehicle 100v by the remote control device 200.

### E. Other Embodiments

### E-1. Another Embodiment 1

At least some functions of the remote control devices 200, 200a, 200b may be one function of the vehicles 100, 100a, 100v and may be one function of the external sensor 300. Also, at least some of the functions of the vehicles 100, 100a, 100v may be a function of the remote control device 200, 200a, 200b. For example, the generation units 138, 138a, 138b may be a function of the remote control devices 200, 200a, 200b. The generation units 138, 138a, 138b generates the mark MA using the second vehicle identification information VI2 of the target vehicle 100t stored in the second memory 202, 200a, 200b, for example. Then, the generation unit 138, 138a, 138b sends the generated image data of the mark MA to the vehicle communication device 130, 130a, 130b. The display control unit 139, 139a of the vehicle communication device 130, 130a, 130b causes the external monitor 135 to display the image data of the mark MA received from the remote control device 200, 200a, 200b. Even in such a configuration, the control system 50, 50a, 50b can generate mark MA representing the vehicle identification information VI and display the generated mark MA on the external monitor 135.

### E-2. Another Embodiment 2

In each of the above-described embodiments, the external sensor 300 is not limited to a camera, and may be, for example, a distance measuring device. The distance measuring device is, for example, a LiDAR (Light Detection And Ranging). The external sensor 300 may be a three-dimensional point cloud representing 100, 100a, 100b, 100v of vehicles. In this case, the server 200, 200a, 200b and the vehicle 100, 100a, 100b, 100v may acquire the vehicle position information by template matching using the three-dimensional point cloud data and the reference-point cloud data prepared in advance.

### E-3. Another Embodiment 3

In the first embodiment to the third embodiment, 200, 200a, 200b performs a process from acquiring the vehicle position information to generating the travel control signal. On the other hand, the vehicle 100, 100a, 100b may perform at least a part of the process from acquiring the vehicle position information to generating the travel control signal. For example, the following forms (1) to (3) may be used.
(1) The server 200, 200a, 200b may acquire the vehicle position information, determine a target position to which the vehicle 100, 100a, 100b should be directed next, and generate a route from the current position of the vehicle 100, 100a, 100b represented in the acquired vehicle position information to the target position. The server 200, 200a, 200b may generate a route to a target position between the current location and the destination, or may generate a route to the destination. 200, 200a, 200b may send the generated route to the vehicles 100. The vehicle 100, 100a, 100b may generate a travel control signal so that the vehicle 100, 100a, 100b travels on the route received from the server 200, 200a, 200b, and control the actuator group 120 using the generated travel control signal.
(2) The server 200, 200a, 200b may acquire the vehicle position information and send the acquired vehicle position information to the vehicle 100, 100a, 100b. The vehicle 100, 100a, 100b may determine a target position to which the vehicle 100 should be directed next, generate a route from the current position of the vehicle 100, 100a, 100b represented in the received vehicle position information to the target position, generate a travel control signal so that the vehicle 100, 100a, 100b travels on the generated route, and control the actuator group 120 using the generated travel control signal.
(3) In the above embodiments (1) and (2), an internal sensor may be mounted on the vehicles 100, 100a, 100b, and a detection result outputted from the internal sensor may be used for at least one of generation of a route and generation of a travel control signal. The inner sensor is a sensor mounted on the vehicles 100, 100a, 100b. The inner sensor may include, for example, a sensor that detects a motion state of the vehicle 100, 100a, 100b, a sensor that detects an operation state of each unit of the vehicle 100, 100a, 100b, and a sensor that detects an environment around the vehicle 100, 100a, 100b. Specifically, the inner sensor may include, for example, a camera, a LiDAR, a millimeter-wave radar, an ultrasonic sensor, a GPS sensor, an accelerometer, a gyroscope, and the like. For example, in the above aspect (1), the server 200, 200a, 200b may acquire the detection result of the internal sensor and reflect the detection result of the internal sensor in the path when generating the path. In the aspect (1), the vehicle 100, 100a, 100b may acquire the detection result of the internal sensor and reflect the detection result of the internal sensor in the travel control signal when generating the travel control signal. In the aspect (2), the vehicle 100, 100a, 100b may acquire the detection result of the internal sensor and reflect the detection result of the internal sensor in the path when generating the path. In the aspect (2), the vehicle 100, 100a, 100b may acquire the detection result of the internal sensor and reflect the detection result of the internal sensor in the travel control signal when generating the travel control signal.

### E-4. Other Embodiment 4

In the fourth embodiment, an internal sensor may be mounted on the vehicle 100v, and a detection result outputted from the internal sensor may be used for at least one of generation of a route and generation of a travel control signal. For example, the vehicle 100v may acquire the detection result of the internal sensor and reflect the detection result of the internal sensor in the route when generating the route. The vehicle 100v may acquire the detection result of the internal sensor and reflect the detection result of the internal sensor in the travel control signal when generating the travel control signal.

### E-5. Another Embodiment 5

In the fourth embodiment, the vehicle 100v acquires the vehicle position information using the detection result of the external sensor 300. On the other hand, an internal sensor is mounted on the vehicle 100v, and the vehicle 100v may acquire the vehicle position information using the detection result of the internal sensor, determine a target position to which the vehicle 100v should be directed next, generate a route from the current position of the vehicle 100v represented in the acquired vehicle position information to the target position, generate a travel control signal for traveling on the generated route, and control the actuator group 120 using the generated travel control signal. In this case, the vehicle 100v can travel without using the detection result of the external sensor 300 at all. The vehicle 100v may acquire the target arrival time and the traffic jam information from the outside of the vehicle 100v and reflect the target arrival time and the traffic jam information on at least one of the route and the travel control signal.

### E-6. Another Embodiment 6

In the embodiments from the first embodiment to the third embodiment, the server 200, 200a, 200b automatically generates travel control signals to be sent to the vehicle 100, 100a, 100b. On the other hand, the server 200 may generate a travel control signal to be sent to the vehicle 100, 100a, 100b in accordance with an operation of an external operator located outside the vehicle 100, 100a, 100b. For example, an external operator may operate a control device including a display for displaying captured images outputted from the external sensor 300, a steering for remotely controlling the vehicle 100, 100a, 100b, an accelerator pedal, a brake pedal, and a communication device for communicating with the server 200, 200a, 200b through wired communication or wireless communication, and the server 200, 200a, 200b may generate a travel control signal corresponding to an operation applied to the control device.

### E-7. Other Embodiment 7

In the above-described embodiments, the vehicle 100, 100a, 100b, 100v may have a configuration that can be moved by unmanned driving, and may be, for example, in the form of a platform that includes the configuration described below. Specifically, the vehicle 100, 100a, 100b, 100v may include at least a vehicle control device 110, 110a, 110v and an actuator group 120 in order to perform three functions of “running,” “turning,” and “stopping” by unmanned driving. When the vehicle 100, 100a, 100b, 100v acquires information from the outside for unmanned driving, the vehicle 100, 100a, 100b, 100v may further include a communication device 130, 130a, 130b. That is, in the vehicle 100, 100a, 100b, 100v that can be moved by unmanned driving, at least a part of an interior component such as a driver's seat or a dashboard may not be mounted, at least a part of an exterior component such as a bumper or a fender may not be mounted, and a body shell may not be mounted. In this case, the remaining components such as the body shell may be mounted on the vehicle 100, 100a, 100b, 100v before the vehicle 100, 100a, 100b, 100v is shipped from the factory FC, or the remaining components such as the body shell may be mounted on the vehicle 100, 100a, 100b, 100v after the vehicle 100, 100a, 100b, 100v is shipped from the factory FC while the remaining components such as the body shell are not mounted on the vehicle 100, 100a, 100b, 100v. Each component may be attached from any direction, such as the upper, lower, front, back, right or left side of the vehicle 100, 100a, 100b, 100v, may be attached from the same direction, each may be attached from different directions. It should be noted that the position determination can be performed in the same manner as in the vehicles 100, 100a, 100b, 100v according to the first embodiment.

### E-8. Another Embodiment 8

The vehicles 100, 100a, 100b, 100v may be manufactured by combining a plurality of modules. Modules refer to units composed of one or more components grouped according to the configuration and function of the vehicles 100, 100a, 100b, 100v. For example, the platform of the vehicle 100, 100a, 100b, 100v may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. Also, in addition to or instead of the platform, parts of the vehicles 100, 100a, 100b, 100v that differ from the platform may be modularized. Further, the various modules may include any exterior parts such as bumpers and grills, and any interior parts such as sheets and consoles. In addition, the present disclosure is not limited to vehicles 100, 100a, 100b, 100v, and a moving object of any aspect may be manufactured by combining a plurality of modules. Such a module may be manufactured, for example, by joining a plurality of parts by welding, a fixture, or the like, or may be manufactured by integrally molding at least a part of the module as one part by casting. Molding techniques for integrally molding at least a portion of a module as one part are also referred to as gigacasting or megacasting. By using the gigacasting, each part of the moving object, which has been conventionally formed by joining a plurality of parts, can be formed as one part. For example, the front module, the central module, and the rear module described above may be manufactured using gigacasting.

### E-9. Other Embodiment 9

Transporting the vehicle 100, 100a, 100b, 100v by using the traveling of the vehicle 100, 100a, 100b, 100v by the unmanned driving is also referred to as “self-propelled conveyance”. A configuration for realizing self-propelled conveyance is also referred to as a “vehicle remote control autonomous traveling conveyance system”. Further, a production method of producing vehicles 100, 100a, 100b, 100v by using self-propelled conveyance is also referred to as “self-propelled production”. In self-propelled manufacturing, for example, at least a part of the conveyance of the vehicle 100, 100a, 100b, 100v is realized by self-propelled conveyance in a factory FC that manufactures the vehicle 100, 100a, 100b, 100v.

### E-10. Other Embodiment 10

In each of the above-described embodiments, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

The present disclosure is not limited to each of the above embodiments, and can be realized by various configurations without departing from the spirit thereof. For example, the technical features of the embodiments corresponding to the technical features in the respective embodiments described in Summary can be appropriately replaced or combined in order to solve some or all of the above-described problems or to achieve some or all of the above-described effects. Further, when the technical features are not described as essential in the present specification, these can be deleted as appropriate.

What is claimed is:

1. A control device, comprising:
an actual data acquisition unit configured to acquire actual data on either or both of a mark displayed on an external monitor mounted on a moving object that is movable by remote control and acquired information acquired using the mark, the acquired information including identification information for identifying the moving object;
a reference data acquisition unit configured to acquire reference data corresponding to the actual data; and
a remote control unit configured to remotely control the moving object and configured to perform different processes related to movement of the moving object between when the actual data and the reference data match each other and when the actual data and the reference data do not match each other.

2. The control device according to claim 1, wherein
the identification information is stored in each of a first memory of a moving object control device mounted on the moving object and a second memory of the control device,
an item of first identification information that is the identification information stored in the first memory has been set according to a manufacturing process being performed on the moving object,
the control device further includes a process acquisition unit configured to acquire process information indicating the manufacturing process being performed on the moving object, and
when the actual data acquisition unit acquires, as the actual data, the first identification information represented by the mark,
the reference data acquisition unit acquires, as the reference data, at least information on the item according to the manufacturing process identified by the process information out of second identification information that is the identification information stored in the second memory.

3. The control device according to claim 1, wherein
the identification information is stored in each of a first memory of a moving object control device mounted on the moving object and a second memory of the control device,
when the mark is generated using at least first identification information that is the identification information stored in the first memory, the first identification information represented by the mark includes unique information unique to the moving object, and the actual data acquisition unit acquires, as the actual data, the first identification information represented by the mark, the reference data acquisition unit acquires, as the reference data, at least second identification information that is the identification information stored in the second memory, the second identification information including the unique information,
when the mark is generated using the second identification information and not using the first identification information, the second identification information represented by the mark includes the unique information, and the actual data acquisition unit acquires, as the actual data, the second identification information represented by the mark, the reference data acquisition unit acquires, as the reference data, at least the first identification information including the unique information, and
when the mark is generated using at least the first identification information, the first identification information represented by the mark does not include the unique information and includes non-unique information other than the unique information, and the actual data acquisition unit acquires, as the actual data, the non-unique information included in the first identification information represented by the mark and the unique information acquired using access information represented by the mark, the reference data acquisition unit acquires, as the reference data, at least the second identification information including the unique information and the non-unique information, the access information being information for accessing the first memory.

4. A control system, comprising:
a moving object that is movable by remote control; and
a control device installed at a place different from the moving object, wherein
the moving object includes a communication device and a moving object control device,
the communication device includes
a generation unit configured to generate a mark using at least identification information for identifying the moving object, the identification information being information acquired from either or both of the control device and the moving object control device, and
an external monitor configured to display the mark, and
the control device includes
an actual data acquisition unit configured to acquire actual data on either or both of the mark displayed on the external monitor and acquired information acquired using the mark, the acquired information including the identification information,
a reference data acquisition unit configured to acquire reference data corresponding to the actual data, and
a remote control unit configured to remotely control the moving object and configured to perform different processes related to movement of the moving object between when the actual data and the reference data match each other and when the actual data and the reference data do not match each other.

5. A control system, comprising:
a moving object that is movable by remote control; and
a control device installed at a place different from the moving object, wherein
the moving object includes a communication device, the communication device including an external monitor configured to display a mark acquired from the control device, and
the control device includes
a memory configured to store identification information for identifying the moving object,
a generation unit configured to generate the mark using at least the identification information stored in the memory,
an actual data acquisition unit configured to acquire actual data on either or both of the mark displayed on the external monitor and acquired information acquired using the mark, the acquired information including the identification information,
a reference data acquisition unit configured to acquire reference data corresponding to the actual data, and
a remote control unit configured to remotely control the moving object and configured to perform different processes related to movement of the moving object between when the actual data and the reference data match each other and when the actual data and the reference data do not match each other.
